(19) United States
(12) Patent Application Publication
(10) Pub. No.: US 2026/0270959 A1
(43) Pub. Date: Sep. 10, 2026

(54) METHODS, ARCHITECTURES, APPARATUSES AND SYSTEMS FOR DISTRIBUTED COMPUTATION AND SYNCHRONIZATION IN WIRELESS LOCAL AREA NETWORKS (WLAN)

(71) Applicant: InterDigital Patent Holdings, Inc., Wilmington, DE (US)

(72) Inventors: Alphan Sahin, Columbia, SC (US); Rui Yang, Greenlawn, NY (US); Mahmoud Saad, L’Ile Bizard (CA); Ying Wang, Easton, PA (US); Hanqing Lou, Syosset, NY (US); Xiaofei Wang, North Caldwell, NJ (US)

(21) Appl. No.: 19/073,407

(22) Filed: Mar. 7, 2025

(51) Int. Cl. H04W 72/044; H04L 5/00; H04W 8/22; H04W 72/21

(52) U.S. Cl. CPC H04W 72/044; H04L 5/0048; H04L 5/0055; H04W 8/22; H04W 72/21

(57) ABSTRACT

Procedures, methods, architectures, apparatuses, systems, devices, and computer program products related to distributed computation and/or synchronization in wireless networks are provided. For example, methods described herein can facilitate distributed frequency, amplitude, and phase synchronization for multiple STAs for over-the-air-computation via phased coded pilots and/or via uplink sounding.

### FIELD

Example embodiments described in the present disclosure are generally directed to the fields of communications, software and encoding, including, for example, to methods, architectures, apparatuses, systems related to distributed computation and/or synchronization in wireless networks.

### BACKGROUND

Over-the-air computation (OAC) is an approach to perform computations by exploiting the signal superposition property of wireless multiple-access channels. OAC combines the computation and communication tasks in one framework to reduce the utilization of limited wireless resources.

### SUMMARY

An embodiment may include a method, which may be performed or implemented by an access point (AP). The method may include transmitting, to one or more STAs (e.g., non-AP STAs), a first frame requesting respective signal aggregation to be performed by the STAs based on an exchange of capability information associated with the signal aggregation. The method may include transmitting a first pilot transmission, and receiving, from the STAs, second pilot transmissions that may include a phase encoding of the first pilot transmission. The phase encoding associated with each of the STAs (e.g., the phase encoding of the first pilot as transmitted by each of the STAs) is based on a phase change of the first pilot transmission on respective downlink (DL) channels between the AP and each of the STAs. The method may include transmitting, to the STAs, a first signal that is phase encoded based on (1) a determined phase change in a respective uplink (UL) channel between the AP and each of the plurality of non-AP STAs and/or (2) a target phase value, and receiving second signals having (e.g., each having or being associated with) a phase that is aligned with the target phase value. The method may include transmitting, to the STAs, a trigger frame soliciting uplink (UL) physical protocol data units (PPDUs) from the STAs. The trigger frame may include phase information for one or more of the STAs (e.g., each of the STAs) based on the phase encoding for the STAs (e.g., each of the STAs) meeting the target phase value. The method may include receiving, from the STAs, the UL PPDUs. The UL PPDUs may be aggregated on the same time-frequency resources via the signal aggregation. For example, the UL PPDUs may be aggregated to perform computation of a distributed task.

An embodiment may be directed to an access point (AP) including circuitry, such as a processor and/or transceiver. The AP may be configured to transmit, to one or more STAs (e.g., non-AP STAs), a first frame requesting respective signal aggregation to be performed by the STAs based on an exchange of capability information associated with the signal aggregation. The AP may be configured to transmit a first pilot transmission, and to receive, from the STAs, second pilot transmissions that may include a phase encoding of the first pilot transmission. The phase encoding associated with each of the STAs (e.g., the phase encoding of the first pilot as transmitted by each of the STAs) is based on a phase change of the first pilot transmission on respective downlink (DL) channels between the AP and each of the STAs. The AP may be configured to transmit, to the STAs, a first signal that is phase encoded based on (1) a determined phase change in a respective uplink (UL) channel between the AP and each of the plurality of non-AP STAs and/or (2) a target phase value, and receiving second signals having (e.g., each having or being associated with) a phase that is aligned with the target phase value. The AP may be configured to transmit, to the STAs, a trigger frame soliciting uplink (UL) physical protocol data units (PPDUs) from the STAs. The trigger frame may include phase information for one or more of the STAs (e.g., each of the STAs) based on the phase encoding for the STAs (e.g., each of the STAs) meeting the target phase value. The AP may be configured to receive, from the STAs, the UL PPDUs. The UL PPDUs may be aggregated on the same time-frequency resources via the signal aggregation. For example, the UL PPDUs may be aggregated to perform computation of a distributed task.

An embodiment may be directed to a station (STA) that includes circuitry, such as a processor and/or transceiver. The STA may be configured to receive, from an access point (AP), a first frame requesting signal aggregation to be performed based on an exchange of capability information associated with the signal aggregation, and to receive, from the AP, a first pilot transmission. The STA may be configured to transmit, to the AP, a second pilot transmission that includes a phase encoding of the first pilot transmission. The phase encoding of the first pilot may be based on a phase change of the first pilot transmission on a downlink (DL) channel between the AP and the STA. The STA may be configured to receive, from the AP, a first signal that is phase encoded based on (1) a determined phase change in a respective uplink (UL) channel between the AP and the STA and/or (2) a target phase value. The STA may be configured to transmit a second signal having a phase that is aligned with the target phase value, and to receive, from the AP, a trigger frame soliciting an uplink (UL) physical protocol data units (PPDU). The trigger frame may include phase information for the STA that may be based on the phase encoding for the STA meeting the target phase value. The STA may be configured to transmit, to the AP, the UL PPDU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A illustrates the conventional method of handling computation and communication tasks;

FIG. 2B illustrates an example of low-latency computation in wireless multiple access channels with OAC, according to an embodiment;

FIG. 3 illustrates an example procedure for federated learning over a wireless network based on gradient aggregation, according to certain embodiments; and

FIG. 4 illustrates an example system diagram, according to certain embodiments;

FIG. 5 is a diagram illustrating the phases for computation over wireless networks (CoWN), according to some embodiments;

FIG. 6 is a diagram illustrating an example of the setup and configuration phase, according to some embodiments;

FIG. 7A illustrates an example of open-loop calibration, according to some embodiments;

FIG. 7B illustrates an example of closed-loop calibration with a timing measurement request, according to some embodiments;

FIG. 8A illustrates an example of an AP-centric CR procedure with a timer, according to some embodiments;

FIG. 8B illustrates an example of an AP-centric CR procedure with pooling, according to some embodiments;

FIG. 9 illustrates an example of a STA-centric procedure, according to some embodiments;

FIG. 10 illustrates an example of a phase alignment procedure with phase-coded pilots, according to an embodiment;

FIG. 11 illustrates a flowchart of a method for the phase alignment procedure with phase-coded pilots, according to certain embodiments;

FIG. 12 illustrates an example diagram of amplitude alignment procedure with phase-coded pilots while maintaining phase alignment, according to certain embodiments;

FIG. 13 illustrates a flowchart of a method for a phase and amplitude alignment procedure with phase-coded pilots, according to certain embodiments;

FIG. 14 illustrates a diagram depicting an amplitude alignment procedure with amplitude-coded pilots, according to some embodiments;

FIG. 15A illustrates an example sequential phase and amplitude alignment with phase/amplitude coded pilots, according to some embodiments;

FIG. 15B illustrates an example sequential phase and amplitude alignment with phase/amplitude coded pilots with an additional trigger frame for triggering aggregation, according to some embodiments;

FIG. 16A illustrates an example of parallel phase and amplitude alignment with phase/amplitude coded pilots, according to some embodiments;

FIG. 16B illustrates an example parallel phase and amplitude alignment with phase/amplitude coded pilots with an additional trigger frame for triggering aggregation, according to some embodiments;

FIG. 17 illustrates an example parallel-sequential hybrid phase and amplitude alignment with phase/amplitude coded pilots, according to some embodiments;

FIG. 18 illustrates an example parallel-sequential hybrid phase and amplitude alignment with phase/amplitude coded pilots with an additional trigger frame for triggering aggregation, according to some embodiments;

FIG. 19A illustrates an example of a PPDU structure for trigger-based PPDU with phase/amplitude coded pilots or sequences, according to certain embodiments;

FIG. 19B illustrates an example of a PPDU structure for trigger-based PPDU with phase/amplitude coded pilots or sequences, according to certain embodiments;

FIG. 19C illustrates an example of a PPDU structure for trigger-based PPDU with phase/amplitude coded pilots or sequences, according to certain embodiments;

FIG. 20A illustrates an example of a sequential method, according to certain embodiments;

FIG. 20B illustrates an example of a parallel method, according to certain embodiments;

FIG. 21 illustrates an example of a parallel-sequential hybrid method, according to certain embodiments;

FIG. 22 illustrates an example of the structure of an OAC PPDU, according to some embodiments;

FIG. 23 illustrates an example of aggregating non-negative and negative-valued parameters on different resources to support non-coherent aggregation, according to certain embodiments;

FIG. 24 illustrates an example of the broadcasting of OAC results or the derived parameters (e.g., updated neural network parameters) based on OAC results, according to some embodiments;

FIG. 25 illustrates an example of a teardown, termination and/or pause request and response from the non-AP STAs, according to certain embodiments;

FIG. 26 illustrates an example flow diagram of a method, according to some embodiments; and

FIG. 27 illustrates an example flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

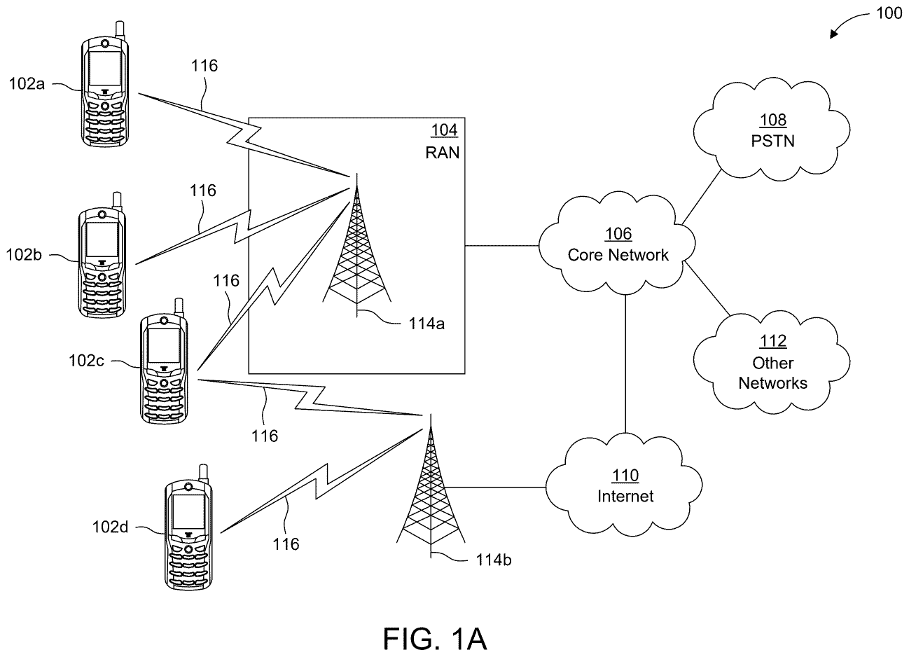

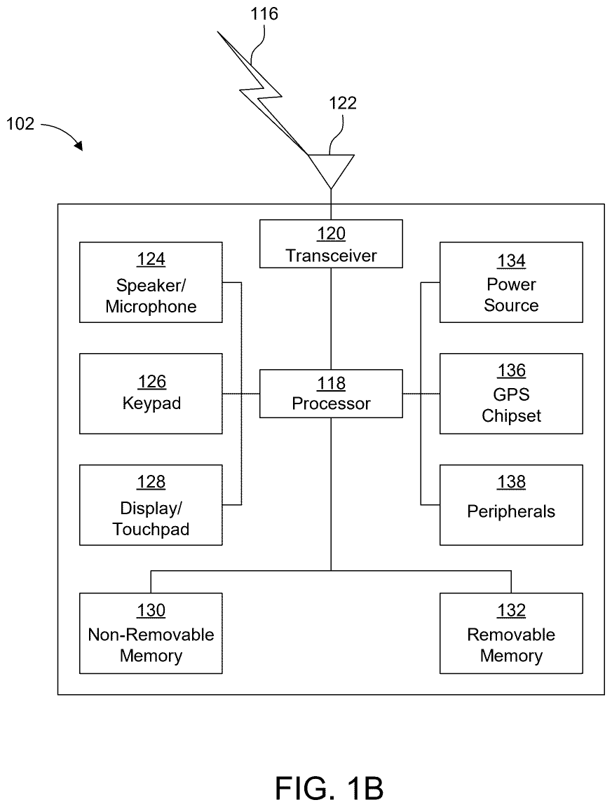

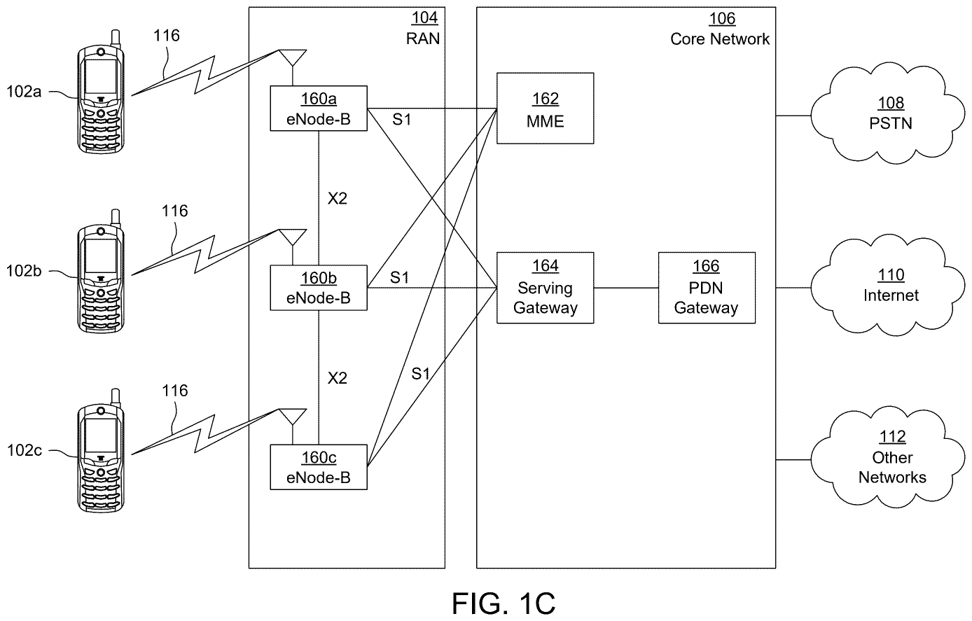

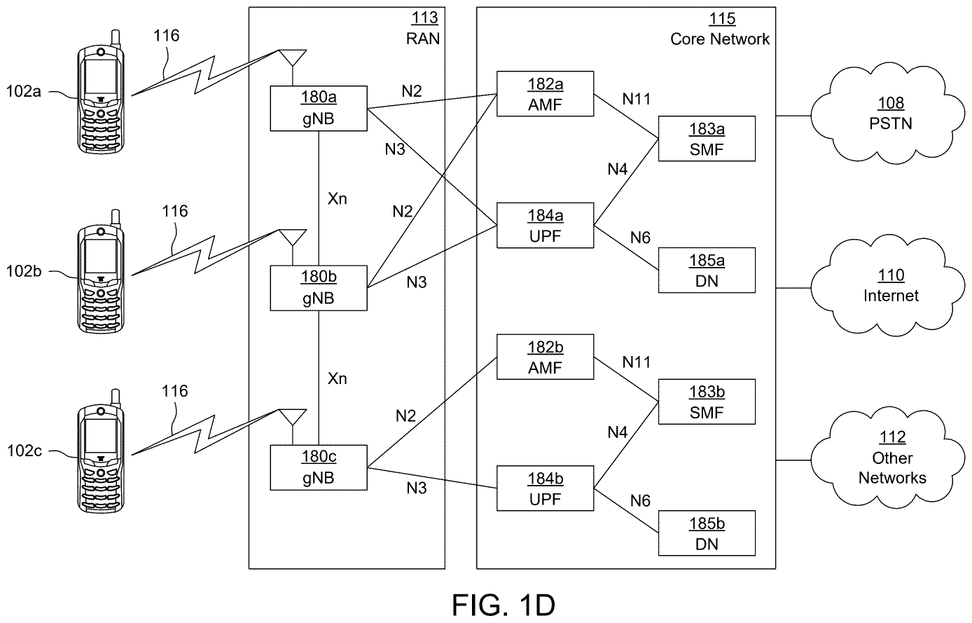

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements or peripherals 138, which may include one or more software and/or hardware modules or units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor, and the like.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP (e.g., See IEEE Std 802.11™-2020: Wireless LAN Medium Access Control (MAC) and Physical Layer (PHY) Specifications [1]). The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA (e.g., See IEEE P802.11ax™/D8.0: Wireless LAN Medium Access Control (MAC) and Physical Layer (PHY) Specifications [2]). The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

Sub 1 GHz modes of operation are supported by 802.11af and 802.11ah (e.g., See IEEE P802.11-REVme™/D5.0, Wireless LAN Medium Access Control (MAC) and Physical Layer (PHY) Specifications, February 2024 [3]). For these specifications the channel operating bandwidths, and the number of OFDM subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel may therefore be limited by the STA that supports the smallest bandwidth operating mode in the BSS. In the example of 802.11ah, the primary channel may be 1 MHz wide if there are STAs (e.g., MTC type devices) that only support a 1 MHz mode even if the AP, and other STAs in the BSS, may support 2 MHz, 4 MHz, 8 MHz, 16 MHz, or other channel bandwidth operating modes. The carrier sensing and NAV settings depend on the status of the primary channel, i.e., if the primary channel is busy, for example, due to a STA supporting only a 1 MHz operating mode is transmitting to the AP, then the entire available frequency bands may be considered busy even though majority of it stays idle and available.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “serving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

Machine learning (ML) has recently been viewed as an important technology for many emerging applications, including autonomous driving, augmented reality, wireless sensing, general-purpose robotics, etc. Many of these applications require high throughput and/or low latency wireless connectivity between data-generating nodes (e.g., IoT devices, virtual reality headsets, sensors, smartphones) and processing units (e.g., core network, servers, routers). Currently, however, the existing wireless networks may not meet stringent requirements due to sophisticated machine learning algorithms, especially when the underlying computations (e.g., training a neural network) require low latency and high throughput wireless connectivity between many nodes. To solve this problem, as a general theme, distributed optimization over large-scale networks with paradigms, such as federated learning, split learning, distributed learning, and consensus, has been heavily studied in academia and industry. Various strategies have also been investigated in industrial standards, including IEEE and 3GPP, but currently only at the network architecture level or merely as a use case to assess the traffic requirement. To enable those new paradigms over standardized wireless communication networks, the existing radio technologies in standards, such as 6G and Wi-Fi, including PHY and MAC layer protocols, need to be enhanced or redesigned to overcome some challenges introduced by those applications. Hence, some advanced PHY and MAC protocols based on fundamental wireless technologies that support machine learning paradigms may need to be introduced into those standards. To this end, there is growing attention on the efficient computation methods over wireless technologies.

Traditionally, communication and computation are viewed as separate tasks. This approach has been very effective from the engineering perspective, as isolated optimizations can be performed. However, for many computation-oriented applications, the ultimate goal of the network is a mathematical function (e.g., arithmetic mean, maximum, minimum) of the local information distributed at the different devices rather than the local information itself. In such scenarios, information or theoretical results show that harnessing the interference in a multiple-access channel for computation, i.e., over-the-air computation (OAC), can provide a significantly higher achievable computation rate than separating communication and computation tasks. With this in mind, some example embodiments described herein provide a protocol to enable over-the-air computation (OAC) in wireless networks, particularly for IEEE 802.11 and/or 3GPP networks.

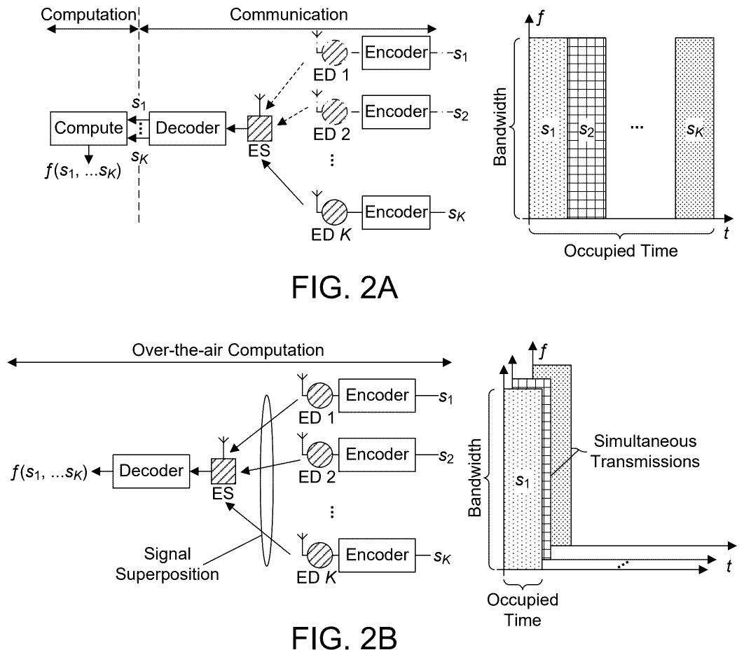

Over-the-air computation (OAC) is an approach to perform computations by exploiting the signal superposition property of wireless multiple-access channels. It combines the computation and communication tasks in one framework to reduce the utilization of limited wireless resources. The distinct feature of OAC is that it does not use typical orthogonal multiple access (OMA) methods, such as orthogonal frequency division multiple access (OFDMA) or time-domain division multiple access (TDMA), to acquire the data from each of the data-generating nodes, as illustrated in FIG. 2A.

In particular, FIG. 2A illustrates the conventional method of handling computation and communication tasks. In such a method, the occupied time linearly grows with the number of edge devices since they use orthogonal resources via TDMA. The ES must wait for the last ED to perform computation, causing higher latency.

Instead, with OAC, the edge devices (EDs) (e.g., all the EDs) may transmit simultaneously, as can be seen in the example of FIG. 2B, where the signal superposition in the channel leads to the desired computation result at the edge server(ES). Specifically, the example of FIG. 2B illustrates low-latency computation in wireless multiple access channels with OAC. The edge devices (EDs) transmit simultaneously for computation in the channel. By enabling snap-shot calculation over the air, OAC eliminates the latency scaled by the number of user equipment (UE) devices, stations (STAs), or sensors. Hence, it is a fundamental, timely, and disruptive technology to the traditional way of handling computation and communication tasks independently.

It is also noted that by manipulating the encoder and decoders at the EDs and ES, OAC can calculate any function in the form given by

$$f ( {s}_{1} , {s}_{2} , … , {s}_{K} ) = φ ( {\sum }_{k = 1}^{K} {ψ}_{k} ( {s}_{k} ) ) ,$$

where φ(·) is the outer function, φₖ(·) is the inner function, and sₖ is the parameter at the kth device. Table 1 below provides examples of several over-the-air computable functions (where [symbol] [·] is indicator function, p₀(ϵ)>0 is a number that determines the function approximation for a given error ϵ).

It is also noted that the parameters to be aggregated, i.e., sₖ, may be a complex-valued, real-valued, positive, or non-negative variable and may encode two real-valued variables as complex numbers. It may also be a part of a discrete set of numbers (e.g., a quadrature amplitude modulation constellation) for digital OAC. It may also be a continuous variable for analog OAC.

TABLE 1

| Description | f(s₁, s₂, ... , sₖ) | ψₖ(x) | φ(x) |
|---|---|---|---|
| Arithmetic mean | $\frac{\text{?}}{K} \text{?}$ | x | $\text{?}$ |
| Weighted sum | $\text{?} ∈ ℝ$ | wₖx | x |
| Polynomial function | $\text{?} ∈ ℝ$ | cₖ₋₁x^{k-1} | x |
| Majority vote | $sign ( \text{?} sign ( \text{?} ) )$ | sign(x) | sign(x) |
| Counting number of EDs with the class C | $\text{?} [ \text{?} ∈ 𝒞 ]$ | x | [symbol] (x ∈ X\| $\text{?}$ |
| p-norm | $( \text{?}$ | \|x\|^{p} | $\text{?}$ |
| Modulo-2 sum | s₁ ⊕ s₂ ... ⊕ s_{K}, sₖ ∈ [symbol] ₂ | x | x mod 2 |
| Approximation of | $\text{?} \geq \text{?}$ | $\text{?} ( x + \text{?} )$ | $\text{?}$ |
| the product | | | |
| Approximation of the geometric mean | $( \text{?} \geq \text{?}$ | $\text{?} ( x + \text{?} )$ | $\text{?}$ |
| Approximation of the cosine of the product | $cos ( \text{?} ) \text{?} \geq \text{?}$ | $\text{?} ( x + \text{?} )$ | cos( [symbol] ) |
| Approximation of the maximum | $\text{?} \geq \text{?}$ | x [symbol] | $\text{?}$ |
| Approximation of the maximum | $\text{?} \geq \text{?}$ | x [symbol] | $\text{?}$ |

[symbol]

indicates data missing or illegible when filed

One possible application for OAC may include federated learning over wireless networks. Federated learning is one of the distributed learning paradigms, where a neural network is aimed to be trained by using the local data generated at the EDs without moving them to a centralized server. With federated learning, instead of datasets being sent, model parameters or gradients are transmitted back and forth between EDs and ES. Since local data never leaves where it is generated, federated learning promotes data privacy for EDs.

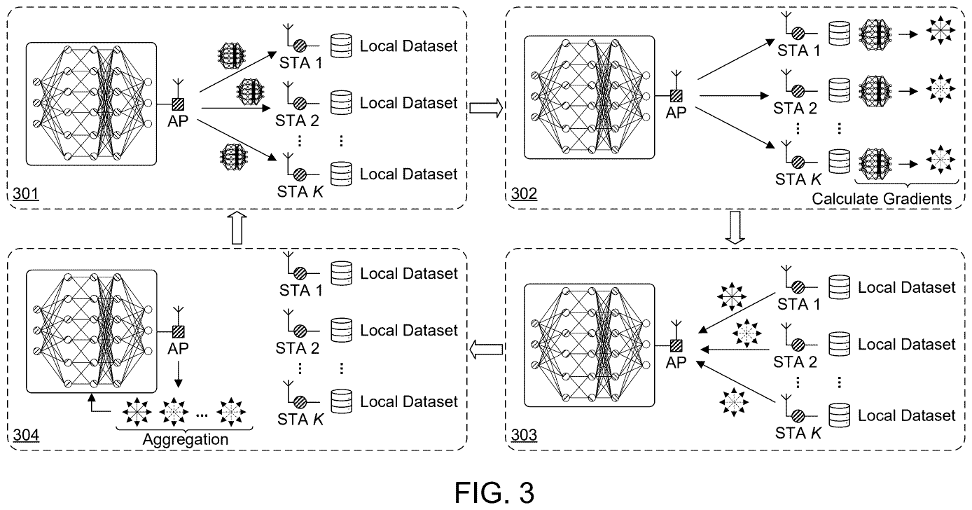

FIG. 3 illustrates an example procedure for federated learning over a wireless network based on gradient aggregation, according to certain embodiments. As shown in the example of FIG. 3, federated learning based on stochastic gradient descent (FedSGD) may may include, as shown in 301, an edge server (ES), e.g., a base station or an AP, which may broadcast the model parameters to edge device(s), e.g., STA(s), UE(s) or WTRU(s). Each of the edge device(s), STA 1, STA 2 . . . STA K, may have or store a local data set (e.g., where the local dataset is not sent or shared). As shown in 302, the edge device(s) (e.g., STA 1, STA 2 . . . . STA K, for example, those that are participating in federated learning), may receive the model parameters and calculate the gradients based on its local dataset. As shown in 303, the edge device(s) may transmit the gradients in the uplink direction to the ES. As shown in 304, the ES may aggregate the received gradients (e.g., arithmetic mean or weighted average) and update the model (and may return to 301 to repeat the process, if needed). For example, the abovementioned procedure may continue or repeat until a convergence criterion is met (e.g., the loss function is less than a threshold).

The rationale behind the FedSGD is explained in the following. Let [symbol] ₖ and [symbol] be the local dataset at the kth STA and the global dataset, i.e., the union of local dataset, i.e.,

$$𝒟 = {⋃}_{k}^{K} {𝒟}_{k} .$$

Let (x₁, y₁)∈ [symbol] be the data sample (e.g., an image) and the corresponding label (e.g., chair) in [symbol] . In a centralized setting where all data is available at the ES, a neural network training problem can be expressed as a general optimization problem given by:

$${w}^{*} = arg {min}_{w} F ( w ) where F ( w ) \hat{=} \frac{1}{\vert 𝒟 \vert} {\sum }_{∀ ( {x}_{l} , {y}_{l} ) ∈ 𝒟} {\underbrace{f ( {x}_{l} , {y}_{l} , w )}}_{loss function} ,$$

where F(w) is function that measures the averaged loss, w∈ [symbol] ^{q} is the vector containing the neural network model parameters with size q, and | [symbol] | is the cardinality of the dataset [symbol] . With (stochastic) gradient descent (SGD), the corresponding update rule to solve the problem above may be expressed as:

$${w}^{( n )} = {w}^{( n - 1 )} - η ∇ F ( {w}^{( n - 1 )} ) for ∇ F ( w ) \hat{=} \frac{1}{\vert 𝒟 \vert} {\sum }_{∀ ( {x}_{l} , {y}_{l} ) ∈ 𝒟} {{\underbrace{∇ f ( {x}_{l} , {y}_{l} , w )}}_{Gradient of the}}_{loss function} ,$$

where η is the learning rate and ∇F (w⁽ⁿ⁻¹⁾) is the global gradient vector.

In the case of federated learning, the global dataset [symbol] is not available at the AP, i.e., STAs do not share their local dataset with the AP. In this scenario, to show why the gradient aggregation (Step 4 in FedSGD) solves the same optimization problem equivalently, the global gradient ∇F(w⁽ⁿ⁻¹⁾) is re-expressed as a weighted summation of the local gradients ∇Fₖ(w⁽ⁿ⁻¹⁾):

$$∇ F ( w ) = \frac{1}{\vert 𝒟 \vert} {\sum }_{∀ ( {x}_{l} , {y}_{l} ) ∈ 𝒟} ∇ f ( {x}_{l} , {y}_{l} , w ) = {\sum }_{k = 1}^{K} \frac{\vert {𝒟}_{k} \vert}{\vert 𝒟 \vert} ∇ {F}_{k} ( w ) for$$

$$∇ {F}_{k} ( w ) \hat{=} \frac{1}{\vert {𝒟}_{k} \vert} {\sum }_{∀ ( {x}_{l} , {y}_{l} ) ∈ {𝒟}_{k}} ∇ f ( {x}_{l} , {y}_{l} , w ) .$$

Thus, by rewriting the update rule, the following identity can be shown:

$${w}^{( n )} = {w}^{( n - 1 )} - η ∇ F ( {w}^{( n - 1 )} ) = {w}^{( n - 1 )} - η {{\underbrace{{\sum }_{k = 1}^{K} \frac{\vert {𝒟}_{k} \vert}{\vert 𝒟 \vert} ∇ {F}_{k} ( w )}}_{Gradient}}_{averaging} .$$

Thus, the update rule can be equivalently expressed as a weighted average of the local gradients, i.e.,

$${\sum }_{k = 1}^{K} \frac{\vert {𝒟}_{k} \vert}{\vert 𝒟 \vert} ∇ {F}_{k} ( w ) ,$$

leading to step 4 of FedSGD. Notice that the weight of kth ED is based on the cardinality of the local dataset and the cardinality of the global dataset, i.e.,

$$\frac{\vert {𝒟}_{k} \vert}{\vert 𝒟 \vert} .$$

If all the STAs have the same number of data samples, the weighted average becomes an arithmetic mean of the local gradients.

It is also noted that the update rule can be model aggregation:

$${w}^{( n )} = {w}^{( n - 1 )} - η ∇ F ( {w}^{( n - 1 )} ) = {{\underbrace{{\sum }_{k = 1}^{K} \frac{\vert {𝒟}_{k} \vert}{\vert 𝒟 \vert} ( {w}^{( n - 1 )} - η ∇ {F}_{k} ( {w}^{( n - 1 )} ) )}}_{Model}}_{averaging} .$$

Thus, in one embodiment, the model parameters may be updated locally at the edge devices, and the edge devices may share the updated model parameters in the uplink direction instead of gradient vectors. Sequentially, the edge server aggregates the model parameters in this equivalent implementation.

In a typical neural network, there can be millions of model parameters, i.e., very large q, leading to a large number of gradients (the number of gradients is equal to the number of learnable parameters). Hence, federated learning can cause significant traffic in a wireless network as millions of parameters need to be exchanged between the radios, especially when there are many STAs. This is known in the literature as the communication bottleneck of federated learning, which can be more pronounced in a bandlimited-communication network like IEEE 802.11.

With OAC, the communication bottleneck can be addressed effectively if the local gradients, i.e., ∇Fₖ(w), can be aggregated in the channel:

$${w}^{( n )} = {w}^{( n - 1 )} - η ∇ F ( {w}^{( n - 1 )} ) = {w}^{( n - 1 )} - {{\underbrace{η {\sum }_{k = 1}^{K} \frac{\vert {𝒟}_{k} \vert}{\vert 𝒟 \vert} ∇ {F}_{k} ( w )}}_{OAC aims to aggregate} .}_{gradients in the air}$$

Note that the weighted mean function needed for gradient aggregation is one of the computable functions with OAC, as can be seen in Table 1. Since the number of consumed resources does not grow with the number of STAs with the concept of OAC, as shown in FIG. 2B, the traffic can be significantly reduced, and training can be done much faster if the wireless network uses the wireless channel as a computation medium.

Despite the advantages of OAC, there are multiple challenges to realizing a reliable OAC scheme in realistic systems due to the fading in wireless channels, time-frequency synchronization errors, hardware impairments, e.g., carrier frequency offset, phase offset, power amplifier non-linearity, and power control. For instance, under a fading channel, the received symbol can be expressed as:

$$y = {\sum }_{k = 1}^{K} {h}_{k} {e}^{j {θ}_{k}} {s}_{k} + {n}_{k} ,$$

where hₖ∈ [symbol] is the fading channel coefficient between kth STA and AP, and n is the noise, which shows that the received signal is not the desired sum, i.e.,

$${\sum }_{k = 1}^{K} {s}_{k} ,$$

under the fading channel. To receive

$${\sum }_{k = 1}^{K} {s}_{k} ,$$

the STAs must precode their transmissions so that the parameters add up constructively in the complex plane (i.e., called coherent summation). Otherwise, the phase of the signals arriving at the AP receiver will not be the same, destroying the coherent aggregation. Thus, to achieve coherent summation, a primary challenge is to estimate and design the precoder that counteracts the impact of fading channels and inevitable hardware impairments such as mismatch between the carrier frequencies of STAs and AP, i.e., carrier frequency offset (CFO) and phase offset (PO) on the coherent superposition. The impacts of fading channel, CFO, and PO on OAC are discussed in detail below.

In addition to the hardware issues, innovations are needed at the protocol level to enable OAC. To date, OAC has not been used in any communication standard or a commercial system. In 3GPP, use cases and potential requirements for 5G to support machine learning applications under three main categories, i.e., federated learning, split learning, and model distribution, are studied, which highlights the need for comprehensive system optimization under communication and computation constraints.

Certain embodiments can address how each STA, with help from its associated AP, can precode its transmitted symbols and parameters (i.e., sₖ) along with procedures to compensate and/or minimize the distortion due to frequency, phase and amplitude mismatches among the network and the propagation channels between the AP and STAs to achieve low-latency computation for applications like a training neural network over wireless networks distributedly.

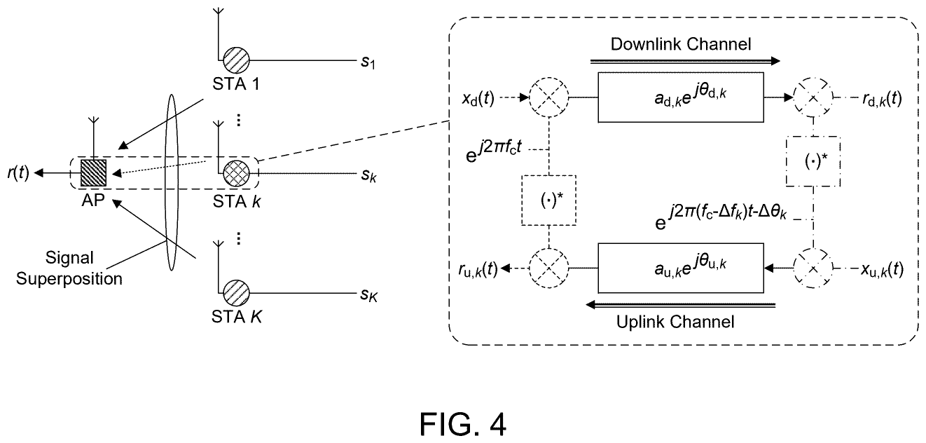

FIG. 4 illustrates an example system diagram, according to certain embodiments. To shed light on how hardware impairment and fading channels affect OAC, FIG. 4 depicts a scenario with K STAs and one AP, where the STAs (e.g., all STAs) are triggered to transmit simultaneously. Let sₖ denote the parameter at the kth STA. Suppose that the goal of the AP is to receive

$${\sum }_{k = 1}^{K} {s}_{k}$$

with signal superposition on the same time-frequency resources.

By considering the channels between STAs and AP, CFO, and PO and the narrowband representation of the signals, received signal at the AP can be expressed as:

$${r}_{u} ( t ) = {\sum }_{k = 1}^{K} {r}_{u , k} ( t ) ,$$

where rₖ(t) is the received signal from the kth STA at the AP, and it can be expressed as:

$${r}_{u , k} ( t ) = {\underbrace{{a}_{u , k} {e}^{j {θ}_{u , k}}}}_{uplink channel} \times {\underbrace{{e}^{- j ( 2 π Δ {f}_{k} f + Δ {θ}_{k} )}}}_{CFO and PO} \times {x}_{u , k} ( t ) ,$$

where x_{u,k}(t)=sₖ is the transmitted signal for aggregation, a_{u,k}e^{jθ}^{_{u,k}} is the uplink channel, and Δfₖ and Δθₖ are the CFO and the PO with respect to the local oscillator of the AP with the carrier frequency of f_{c}, respectively. As shown in the expression of r_{u,k}(t), the phase of the received signal for kth STA is a function of the uplink channel, CFO, and PO, and the phase rapidly changes over time as:

$$∠ {r}_{u , k} ( t ) = {{\underbrace{{θ}_{u , k} - 2 π Δ {f}_{k} t - Δ {θ}_{k}}}_{Phase mismatch due to the}}_{uplink channel , CFO , and PO} + {∠x}_{u , k} ( t ) .$$

The main difference between communications and OAC arises from the fact that rᵤ(t) cannot be expressed as:

$${r}_{u} ( t ) = {\sum }_{k = 1}^{K} {r}_{u , k} ( t ) = {\sum }_{k = 1}^{K} {a}_{u , k} {e}^{j {θ}_{u k}} {e}^{- j ( 2 π Δ {f}_{k} t + {Δθ}_{k} )} \times {s}_{k} = {a}_{common} {e}^{- j ( 2 π Δ {f}_{c o m m o n} t + {Δθ}_{common} )} \times {\underbrace{{\sum }_{k = 1}^{K} {s}_{k}}}_{derired sum} ,$$

with some parameters a_{common}, Δf_{common}, and Δθ_{common} in general. Thus, typical estimation and correction methods relying on the existence of parameters like a_{common}, Δf_{common}, and Δf_{common} (e.g., channel estimation and linear equalization in existing communication systems) are not helpful in obtaining the desired sum, i.e.,

$${\sum }_{k = 1}^{K} {s}_{k} ,$$

via receiver-based processing.

In certain embodiments described herein, the downlink channel between the AP and the kth STA is denoted as a_{d,k}e^{jθ}^{_{d,k}} for a narrowband representation. Thus, the received signal r_{d,k}(t) at the kth STA can be expressed as:

$${r}_{d , k} ( t ) = {\underbrace{{a}_{d , k} {e}^{j {θ}_{d , k}}}}_{downlink channel} \times {\underbrace{{e}^{j ( 2 πΔ {f}_{k} t + {Δθ}_{k} )}}}_{CFO and PO} \times {x}_{d} ( t ) ,$$

where x_{d}(t) is the transmitted signal from the AP. Hence, the phase of the received signal at the kth STA is a function of the downlink channel, CFO, and PO, and, similar to ∠r_{u,k}(t), φr_{d,k}(t) also rapidly changes as a function of time as:

$$∠ {r}_{d , k} ( t ) = {{\underbrace{{θ}_{d , k} + 2 π Δ {f}_{k} t + Δ {θ}_{k}}}_{Phase mismatch due to the}}_{downlink channel , CFO , and PO} + ∠ {x}_{d} ( t ) .$$

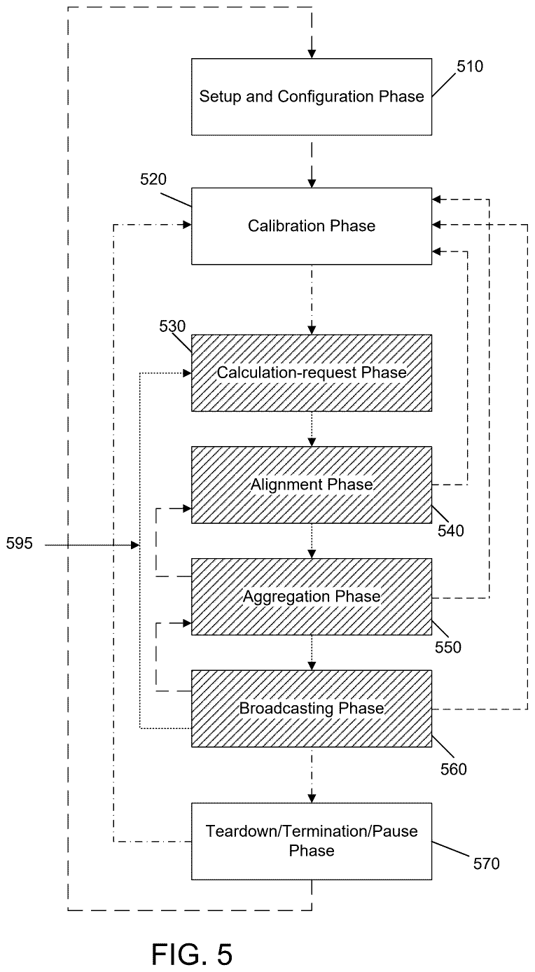

FIG. 5 is a diagram illustrating the phases for computation over wireless networks (CoWN), according to some embodiments. As illustrated in the example of FIG. 5, the phases for CoWN may include the following phases for an arbitrary computation task: setup and configuration phase 510, calibration phase 520, calculation-request phase 530, alignment phase 540, aggregation phase 550, broadcasting phase 560, and teardown, termination and/or pause phase 570.

In the setup and configuration phase 510, the network is configured by an AP or a set of APs (or based on a request from an STA or a group of STAs), the computation tasks may be set and distributed, and the constituent devices (e.g., STAs) in the computation may be determined. Also, hyperparameters related to computation, e.g., learning rate, neural network topology or model graph, inner and outer functions, and digital, analog, coherent, and/or non-coherent aggregation parameters, may be distributed in the network depending on the application. Security-related parameters (e.g., encryption keys) may also be configured in this phase.

In the calibration phase 520, the constituents in the network adjust their physical (PHY) layer and MAC layer parameters to ensure the reliability of computation in a harmonious way. This phase may include coarse power control, time-frequency synchronization, and pre-carrier frequency offset compensation via open or closed-loop calibration procedures.

In the calculation-request phase 530, the purpose is to trigger the STAs to perform local computations based on the parameters indicated in the setup and configuration phases. Once the local computations are done at the STAs, the AP may trigger STAs for aggregation.

In the alignment phase 540, the channel is measured between the APs and STAs for OAC. This phase may include fine CFO tuning, fine time synchronization, phase offset calibration, amplitude alignment, and tighter power control loops through some well-defined procedures to synchronize STAs for the aggregation phase.

In the aggregation phase 550, local computation results are aimed at being aggregated. Two strategies, which not mutually exclusive, may be followed. These strategies are with OAC or without OAC.

In the with OAC strategy, for aggregation, OAC operation may be performed on the assigned time-frequency resources in this phase. Further encoding procedures may ensure the reliability of aggregation. Triggering mechanisms may be employed to initiate the OAC. In this phase, the coordinator may also adjust the hyperparameters of the computation task (e.g., learning rate). The aggregation phase with OAC may also allocate some orthogonal resources for each device to measure the reliability of the aggregation on the AP side through assignment or scheduling.

In the without OAC strategy, the AP or the set of APs may aggregate the local computation results after they acquire them from the STAs. Like the case with OAC, the coordinator may also adjust the hyperparameters of the computation task (e.g., learning rate).

In the broadcasting phase 560, the AP or a set of APs broadcast the computation results or derived computation results (e.g., aggregated model parameters or gradients) to the constituents in the network. Note that the constituents may include all STAs or those who participated in the last aggregation phase.

In the teardown/termination/pause phase 570, the network prepares the devices to terminate the computation task. This phase may include some announcement about the results related to computation or provide additional metadata (e.g., loss function results) to the network's constituents. It may also pause the local computations for a certain duration to save energy or further data sample acquisition.

As shown at 595, the calculation-request phase 530, the alignment phase 540, the aggregation phase 550, and/or the broadcasting phase 650 may constitute the main loop for federated learning iterations. Although, some phases may be omitted and the order may change according to certain embodiments.

Each of the phases will be discussed in further detail below.

It should be noted that, according to certain embodiments, some of the computation phases may be omitted, repeated, and/or looped back until some criteria, e.g., calibration reliability and loss function, are met or the computation task is completed. Hence, some of the phases depicted in the example of FIG. 5 and discussed herein may be skipped and, therefore, should not be considered mandatory or essential according to certain embodiments.

It is noted that the procedures described for the phases discussed herein may be within (1) a basic service set (BSS), i.e., an AP and its associated non-AP STAs, (2) among APs and non-AP STAs in an overlapping BSS (OBBS), and/or (3) among APs on OBSS. Throughout this disclosure, the procedures for the phases above are described for a BSS without loss of generality and may also be employed for the scenarios.

According to some embodiments, a goal of the computation may be arbitrary and/or used for various applications such as wireless federated learning, distributed optimization, consensus, distributed computing, computation of particular functions for sensing or data fusion applications (e.g., maximum temperate measured by the sensors in a warehouse), data centers, or applications in the area of communications such as for a neural network in the physical layer, optimization of a system in a medium-access layer or network layer, or the like.

As introduced above, certain embodiments may include procedures for setup and configuration phase. In the context of 802.11 wireless networking, the Capabilities Information Element refers to a field within a management frame (e.g., a Beacon frame) that details the functionalities and features a network device supports, allowing other devices to determine if they can join and what capabilities are available on that network; for example, acting as an advertisement of the network's capabilities. To indicate whether an STA or an AP supports the OAC, an “OAC Support” feature may also be included in the Capabilities Information Element. To announce the capabilities related to OAC and set the parameters of the OAC operation, an Action Request frame may be sent from the AP to non-AP STA to initiate the agreement and parameters regarding OAC operation in the following phases, and/or an Action Response frame may be sent from the non-AP STA to AP to accept/reject/suggest parameters for the OAC operation in the following phases.

Various parameters may be associated with each of the phases, e.g., they may be sent, received or otherwise used or activated, or the like, during one or more of the phases. The parameters that may be associated with each phase of OAC are discussed in the following.

Parameters associated with setup and configuration may include or indicate any of purpose(s) of CoWN, such as single-shot CoWN or iterative CoWN, single-shot CoWN application type, e.g., data fusion or sensory data aggregation, iterative CoWN application type, e.g., Distributed optimization, distributed optimization, consensus, split learning, federated learning, and the like. Further parameters associated with setup and configuration may include or indicate any of model parameters, learnable parameters, neural network model, architecture, or architecture type (e.g., autoencoder, transformer, convolution neural network, large-language model, etc.), indices of the models (e.g., if there are multiple models), hyperparameters related to training and model optimization (e.g., the dropout probability), the purpose of a neural network to be trained (e.g., a neural network training in PHY such as an autoencoder, image classification, speech recognition), the purpose of optimization or training (e.g., refinement, personalization, training from scratch), the objective function to be optimized (e.g., model update rule and/or their parameters (e.g., stochastic gradient descend (SGD) with momentum or adaptive moment (ADAM) update), the learning rate and learning rate scheduling parameters, the total number of learning global iterations (implicit termination), the number of learning local iterations at the STAs, the batch size used in the gradient calculation (e.g., 100 images), the optimization type, e.g., classification or regression, the loss function used for calculating the gradients (e.g., binary cross entropy or mean square error), the layer index or layer indices to be trained (e.g., the last two layers of the neural network), the sigmoid functions (e.g., linear rectifier, logistic function), the periodic model update rates (through Service Periods) by enabling reservations, Calculation request (CR) capabilities, T_{calc} parameter, and/or maximum computation time), number of validation samples to validate the model (e.g., 100 samples for validation) and/or the samples to validate the neural network, and/or the computation power of the STAs or AP (e.g., how long it takes to calculate gradients) to group the STAs in CoWN based on their computation capabilities (e.g., presence of GPU on the device, supported calculation time (e.g., calculating X number of parameters in T seconds), supported floating-point operations per second (FLOPS), supported performance per watt, e.g., TOPS, bit precision for the model parameters or gradients (e.g., a single bit, 8 bits, 32 bits, 64 bits), and/or computation classes, e.g., Class 1, Class 2 (as a function of the available memory, CPU rate, GPU RAM)).

Parameters associated with the calibration phase may include or indicate any of RF capabilities, the presence of a high-precision oscillator or its PPM values, supported transmit power levels and ranges or steps, whether the same local oscillator drives both the receiver and transmitter RF chain, the support of open-loop calibration or not, parameters regarding PPDU, whether the inclusions of extra fixed sequences in the PPDU (trigger or ACK) are supported or not in the PPDU for trigger or the PPDU for ACK, and/or (e.g., for time alignment) the timed transmission parameters, e.g., ΔT_{target}, discussed in the calibration phase.

Parameters associated with the alignment phase may include or indicate any of desired amplitude level for amplitude alignment, truncation threshold for amplitude alignment (e.g., if the absolute of the fading coefficient is less than this value, the non-AP STA may not transmit on that time-frequency resource), the desired or target phase value θ_{desired}, and/or scrambling phase sequence for θ_{desired} to improve reliability against eavesdropping about OAC results (e.g., encryption by securing θ_{desired}).

Parameters associated with the aggregation phase may include or indicate any of whether non-coherent or coherent aggregation is used in the aggregation phase, digital or analog aggregation (e.g., for digital aggregation (e.g., discrete values of sₖ), the set of all possible values for sₖ and its mapping to the constellation), the supported function lists for OAC (e.g., the inner and outer functions, e.g., majority vote) for OAC, aggregation type in the uplink (e.g., model aggregation, gradient aggregation, or model update aggregation), and/or the noise variance for a promoted differential privacy by injecting some noise into the gradients or model parameters at the non-AP STAs.

Parameters associated with the broadcasting phase may include or indicate any of the broadcasting type (e.g., aggregated model parameters, aggregated gradients, aggregated model updates, and/or majority votes as binary symbols), and/or the noise variance for a promoted differential privacy by injecting some noise into the gradients or model parameters at the AP.

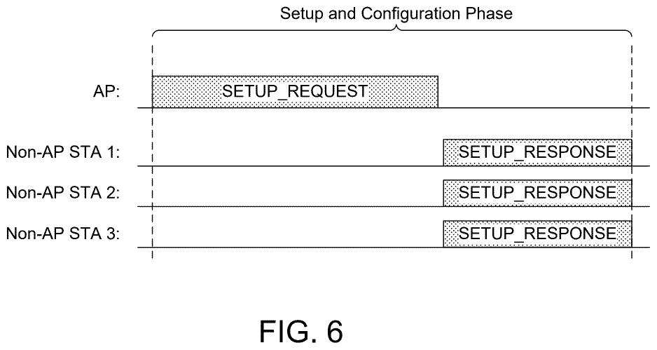

FIG. 6 is a diagram illustrating an example of the setup and configuration phase, according to some embodiments. The AP may learn the capabilities of the non-AP STAs with a special request frame. The AP may also transmit a specific SETUP_REQUEST frame to set up the training in the following phases, and the SETUP_REQUEST frame may have one or more of the parameters above or request the status of specific parameters. In response to the setup frame, the non-AP STA may transmit a SETUP_RESPONSE frame, as shown in the example of FIG. 6. SETUP_RESPONSE frame may include one or more of the parameters above. It is noted that SETUP_REQUEST may also configure or distribute the initial model parameters, validation dataset, training dataset, and/or test dataset depending on the application.

As introduced above, certain embodiments may include procedures associated with a calibration phase. For example, in an embodiment, AP may initiate a calibration phase to ensure that the non-AP STAs' signals can be synchronized in amplitude, time, and frequency in the alignment phase. The calibration phase may be an open loop (no feedback from the AP) or a closed loop (with feedback from the AP).

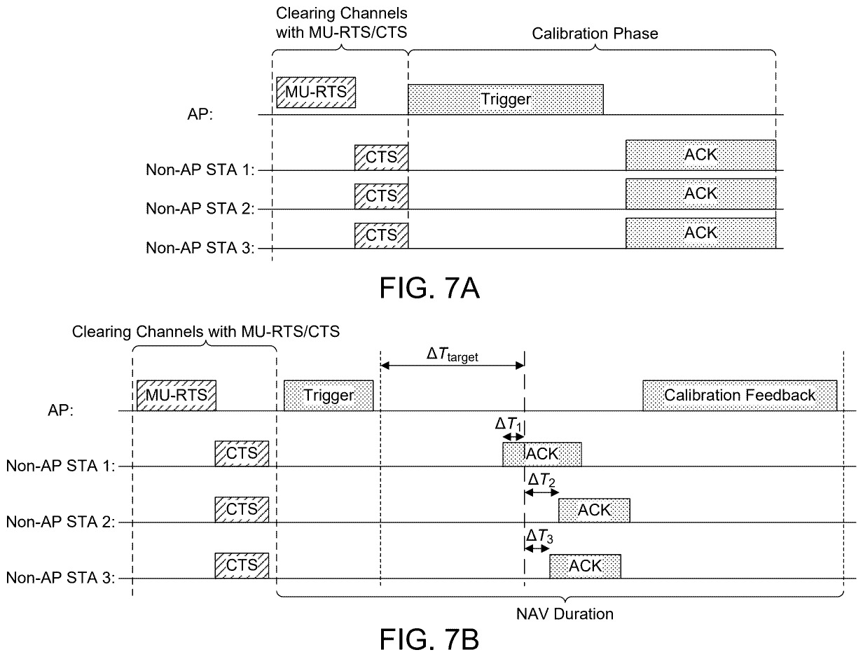

FIG. 7A illustrates an example of open-loop calibration, according to some embodiments. The AP may initiate open-loop calibration by transmitting a specific trigger frame indicating open-loop calibration. Once a non-AP STA receives the trigger frame, it may calculate the carrier frequency offset and power offset. It then tunes its own local oscillator to eliminate the CFO. For example, if the measure CFO is Δf, it tunes its local oscillator to f_{c}+Δf (so that its local oscillator is aligned with the AP's oscillator). Similarly, it may adjust its transmission power based on the power offset. To this end, The corresponding PPDU for trigger frame may include extra fixed sequences to improve calibration reliability. In particular, it may include a longer long-training field (LTF), repeated LTFs, or extra fields with fixed sequences or pilots. If the inclusion of extra fixed sequences in the PPDU is made optional, an indication regarding this feature may be added to the Capabilities Information Element. For amplitude calibration, the calibration trigger may include parameters like 1) the target received signal power and/or the transmit power of the PPDU carrying the triggering frame (STAs may calculate the path loss and determine its transmission power with transmit power and desired received power information). In certain embodiments, STA indices or identities for calibration may also be included.

In response to the calibration trigger frame, a non-AP STA may transmit an ACK frame after calibrating its own transmission, as shown in the example of FIG. 7A. By using the ACK signals, the AP may test whether the calibration is successful. For instance, the AP may measure the CFO and the received signal power of each non-AP STA. If the measured CFO is larger than an implementation-dependent threshold and/or the measured signal amplitude or power is not within an implementation-dependent range, the AP may reinitiate the calibration phase for these non-AP STAs. In some cases, the compensation parameters may not be applied to the entire PPDU for ACK. In this case, the corresponding PPDU may include an extra fixed sequence (a new field or a set of OFDM symbols) where the compensation is applied to only this field. In this case, the AP infers the calibration success by processing this field at the receiver.

In some cases, the calibration may be achieved partially. To eliminate the extra traffic in the network, the trigger frame may indicate the calibration purpose (e.g., the purpose of calibration may be frequency, time, or amplitude compensation). Note that open-loop calibration may also include a preparation step to clear the channel, as shown in the example of FIG. 7A.

One assumption for the aforementioned open-loop calibration is that the same local oscillator drives the transmitter and receiver RF chains at the AP and the non-AP STAs (see the model in FIG. 3) so that frequency offset can be pre-compensated through an open-loop calibration. In some implementations, independent oscillators may exist for transmitter and receiver RF chains, and a closed-loop calibration may be needed. Similarly, timing misalignment due to an inaccurate sample clock period at the STA or AP requires a closed-loop calibration as it can only be measured at the AP side. FIG. 7B illustrates an example of closed-loop calibration with a timing measurement request, according to some embodiments. It is noted that timing measurement requested may be omitted in some embodiments.

For a closed-loop calibration, the procedure may include preparation phase, trigger phase and/or feedback phase. For preparation, the AP may first transmit a multi-user-request-to-send (MU-RTS) signal or other triggering signals for the corresponding non-AP STAs and set the NAV duration to cover calibration phases. In response to the MU-RTS signal, the non-AP STA may transmit a clear-to-send (CTS) signal or other triggering signals to clear the channel. The NAV duration may further include both the aggregation phase and the alignment phase.

For triggering, the AP may transmit a trigger frame for calibration. In response to the calibration trigger, a non-AP STA may transmit an ACK signal, as shown in the example of FIG. 7B. In particular, the ACK signals may be transmitted after ΔT_{target} seconds (i.e., timed transmission). The corresponding calibration PPDU carrying the ACK frames may include some extra fixed sequences to improve the reliability of measurement. In particular, it may include a longer long-training field (LTF), repeated LTFs, or extra fields with fixed sequences or pilots. If the inclusion of extra fixed sequences in the PPDU is made optional, an indication regarding this feature may be added to the Capabilities Information Element as discussed in the setup and calibration phase.

By using the ACK signals transmitted from each STA, the AP may then measure the CFO (i.e., Δfₖ), amplitude mismatch, and timing mismatch (i.e. ΔTₖ) for each non-AP STA.

It is noted that in some cases (e.g., cases where the non-AP STA uses the same oscillator for both transmitter and receiver chains, but the AP does not use the same oscillator for both transmitter and receiver chains), once a non-AP STA receives the trigger frame, it may calculate the carrier frequency offset. It may tune its own local oscillator to eliminate the CFO in the uplink direction. For example, if the measure CFO is Δf, it tunes its local oscillator to f_{c}+Δf (so that its local oscillator is aligned with the AP's oscillator). This may reduce the amount of feedback in the next step.

For feedback, once the AP completes the measurements, it prepares a PPDU to provide feedback regarding the CFO (i.e., Δfₖ), the amplitude mismatch (e.g., increment/decrement factor of the transmission power of the non-AP STAs, such as reducing the transmission power by −3 dB or increasing the transmission power by 5 dB), and the timing mismatch from the desired ΔT_{target} (i.e. ΔTₖ) for all non-AP STAs and transit the corresponding information in the downlink channel. The non-AP STAs (e.g., all non-AP STAs) update their radio settings based on the feedback information regarding CFO, sample-time error, and/or transmission power.

The trigger frame may indicate the calibration purpose (e.g., the purpose of calibration may be frequency, time, or amplitude compensation) to eliminate the extra traffic in the network. For example, the timed transmission for measuring the clock errors may be omitted in some implementations to save time.

As introduced above, certain embodiments may include procedures associated with a calculation-request (CR) phase. The calculation-request (CR) phase may be AP-centric or STA-centric.

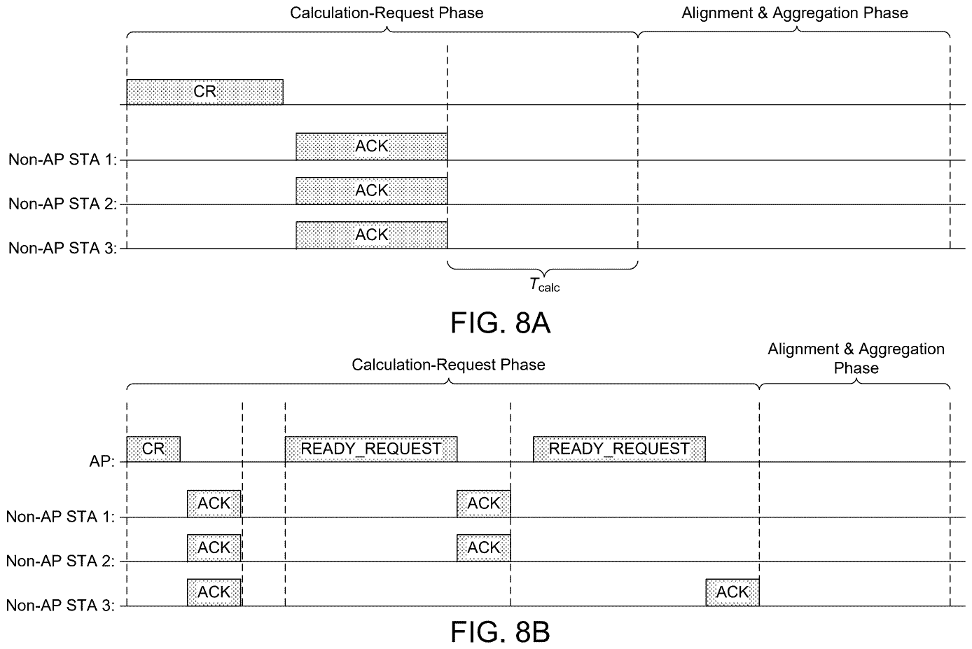

FIG. 8A illustrates an example of an AP-centric CR procedure with a timer, according to some embodiments. For the AP-centric procedure, the AP may also transmit a specific CR_REQUEST frame to indicate the non-AP STAs perform their local computations, e.g., gradient calculations, within seconds. In response to the CR_REQUEST frame, the non-AP STA may transmit an ACK frame, as shown in the example of FIG. 8A. The AP then waits T_{calc} seconds and goes to the alignment and aggregation phase. For this procedure, the AP does not wait for the staggers, but it determines the non-AP STAs that are ready for the computation in the aggregation phase.

FIG. 8B illustrates an example of an AP-centric CR procedure with pooling, according to some embodiments. In this embodiment, after the AP transmits a CR frame to indicate the non-AP STAs perform their local computations, the AP may transmit another frame, the READY_REQUEST frame, to assess if the corresponding STAs are ready for the alignment and aggregation phase, as shown in the example of FIG. 8B. This frame may include the STA indices based on the STA indicated in the CR frame. The AP may transmit this frame multiple times to ensure that all non-AP STAs are ready, or it may continue in the following phase without waiting for the straggler STAs.

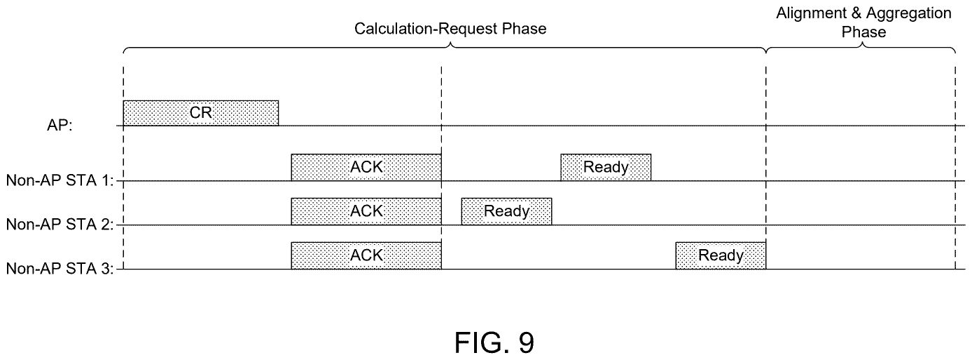

FIG. 9 illustrates an example of a STA-centric procedure, according to some embodiments. For the STA-centric procedure, the AP may also transmit a specific CR frame to indicate the non-AP STAs perform their local computations, e.g., gradient calculations. In response to the CR frame, the non-AP STA may transmit an ACK frame, as shown in the example of FIG. 9. The AP then waits for local calculations to be completed. To this end, each non-AP STA transmits a READY frame to indicate they are ready to transmit their local calculation parameters. Once the AP determines that some of the STAs are ready for the alignment and aggregation phase, it may initiate the alignment and aggregation phases.

As introduced above, certain embodiments may include procedures associated with an alignment phase. For example, an alignment phase may be particularly need if aggregation is handled through OAC. The following procedures may be used for phase, frequency, and/or amplitude alignment.

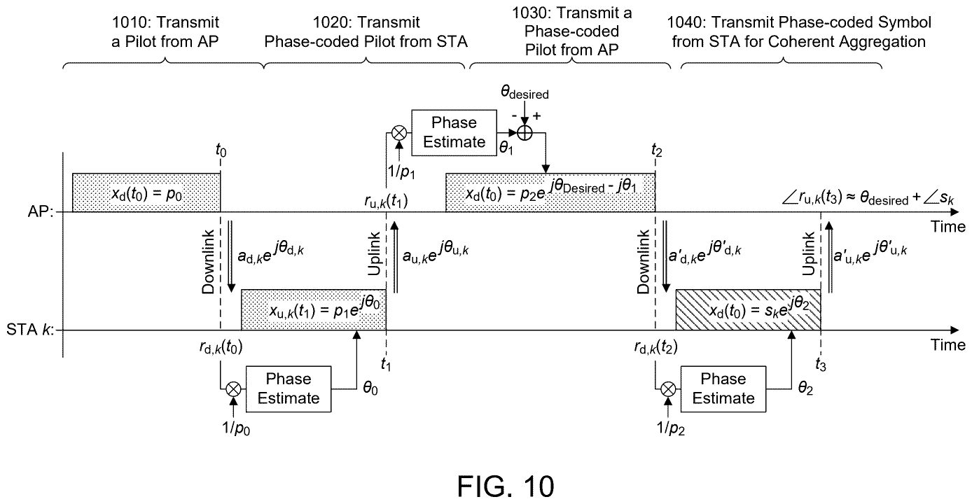

Certain embodiments may include phase and amplitude alignment procedures with coded pilots. An embodiment may include a phase alignment procedure with phase-coded pilots. FIG. 10 illustrates an example of a phase alignment procedure with phase-coded pilots, according to an embodiment. It is supposed that the desired or target phase is θ_{desired} for the received signals from kth STAs at the AP side. To align the received signals from the kth STA to θ_{desired} on the AP side, in one method, the AP and the kth STA can exchange phase-coded pilots in the downlink and uplink directions to estimate and correct the round-trip phase mismatch between the AP and the STA in a coordinated manner. In particular, FIG. 10 illustrates an example of this procedure, based on the mathematical model introduced above.

As illustrated in the example of FIG. 10, at 1010 (t=t₀), the AP may transmit a pilot symbol, e.g., x_{d}(t₀)=p₀, e.g., p₀=1. Thus, the received signal at the kth STA can be expressed as:

$${r}_{d , k} ( {t}_{0} ) = {{\underbrace{{a}_{d , k} {e}^{j {θ}_{d , k}}}}_{downlink}}_{channel} \times {\underbrace{{e}^{j ( 2 π Δ {f}_{k} {t}_{0} + {Δθ}_{k} )}}}_{CFO and PO} \times {p}_{0} .$$

Furthermore, the kth STA may estimate the phase change in the downlink channel as:

$${θ}_{0} = ∠ \frac{{r}_{d , k} ( {t}_{0} )}{{p}_{0}} = ∠ {{\underbrace{{a}_{d , k} {e}^{j {θ}_{d , k}}}}_{downlink}}_{channel} \times {\underbrace{{e}^{j ( 2 πΔ {f}_{k} {t}_{0} + {Δθ}_{k} )}}}_{CFO and PO} = 2 πΔ {f}_{k} {t}_{0} + {Δθ}_{k} + {θ}_{d , k} .$$

As illustrated in the example of FIG. 10, at 1020 (t=t₁), as a response to the pilot signal received in 1010, the kth STA may transmit a phase-coded pilot, i.e., x_{u,k}(t₁)=p₁e^{jθ}^{ₒ}, based on the estimated phase change, i.e., θ₀, in 1010. Thus, the received signal at the AP can be expressed as

$${r}_{u , k} ( {t}_{1} ) = {{\underbrace{{a}_{u , k} {e}^{j {θ}_{u , k}}}}_{uplink}}_{channel} \times {\underbrace{{e}^{- j ( 2 π Δ {f}_{k} {t}_{1} + Δ {θ}_{k} )}}}_{CFO and PO} \times {p}_{1} {e}^{j {θ}_{0}} .$$

The AP then may estimate the phase change in the uplink channel as:

$${θ}_{1} = ∠ \frac{{r}_{u , k} ( {t}_{1} )}{{p}_{1}} = ∠ {{\underbrace{{a}_{u , k} {e}^{j {θ}_{u , k}}}}_{uplink}}_{channel} \times {\underbrace{{e}^{- j ( 2 π Δ {f}_{k} {t}_{1} + Δ {θ}_{k} )}}}_{CFO and PO} \times {e}^{j {θ}_{0}} = 2 π Δ {f}_{k} ( {t}_{0} - {t}_{1} ) + {θ}_{u , k} + {θ}_{d , k} .$$

Thus, the phase offset 40k is eliminated and the impact of CFO on phase rotation is mitigated to 2πΔfₖ(t₀-t₁)≈0 as t₀≈t₁. The remaining phase θ_{u,k}+θ_{d,k} is due to the fading channel.

As illustrated in the example of FIG. 10, at 1030 (t=t₂), as a response to the pilot signal received in 1020, the AP may transmit a phase-coded signal, i.e., x_{d}(t₀)=p₂e^{j(θ}^{_{desired}}^{-θ}^{₁}⁾, based on the estimated phase change, i.e., θ₁, in 1020 and the desired (e.g. target) phase term, i.e., θ_{desired}. Thus, the received signal at the kth STA can be expressed as:

$${r}_{d , k} ( {t}_{2} ) = {{\underbrace{{a}_{d , k}^{′} {e}^{j {θ}_{d , k}^{′}}}}_{downlink}}_{channel} \times {\underbrace{{e}^{j ( 2 π Δ {f}_{k} {t}_{2} + Δ {θ}_{k} )}}}_{CFO and PO} \times {p}_{2} {e}^{j ( {θ}_{desired} - {θ}_{1} )} ,$$

where

$${a}_{d , k}^{′} and {θ}_{d , k}^{′}$$

denote the amplitude and phase response in the downlink multipath channel, respectively. The kth STA may then estimate the phase change in the downlink channel as:

$${θ}_{2} = ∠ \frac{{r}_{d , k} ( {t}_{2} )}{{p}_{2}} = ∠ {{\underbrace{{a}_{d , k}^{′} {e}^{j {θ}_{d , k}^{′}}}}_{downlink}}_{channel} \times {\underbrace{{e}^{j ( 2 π Δ {f}_{k} {t}_{2} + Δ {θ}_{k} )}}}_{CFO and PO} \times {p}_{2} {e}^{j ( {θ}_{desired} - {θ}_{1} )} = {θ}_{d e s i r e d} + 2 π Δ {f}_{k} ( {t}_{2} + {t}_{1} - {t}_{0} ) - {θ}_{u , k} + Δ {θ}_{k} + {θ}_{d , k}^{′} - {θ}_{d , k} .$$

As illustrated in the example of FIG. 10, at 1040 (t=t₃), for coherent aggregation, the kth STA may transmit a phase-coded parameter sₖ to be aggregated, i.e., x_{u,k}(t₃)=sₖe^{jθ}^{₂}. Thus, the received signal at the AP can be expressed as:

$${r}_{u , k} ( {t}_{3} ) = {{\underbrace{{a}_{u , k}^{′} {e}^{j {θ}_{u , k}^{′}}}}_{uplink}}_{channel} \times {\underbrace{{e}^{j ( 2 π Δ {f}_{k} {t}_{3} + Δ {θ}_{k} )}}}_{CFO and PO} \times {s}_{k} {e}^{j {θ}_{2}} .$$

Thus, the phase of the received signal is aligned with the desired (e.g., target) phase θ_{desired}:

$$\begin{matrix}{θ}_{3} = ∠ {r}_{u , k} ( {t}_{3} ) = ∠ {{\underbrace{{a}_{u , k}^{′} {e}^{j {θ}_{u , k}^{′}}}}_{uplink}}_{channel} \times {\underbrace{{e}^{j ( 2 π Δ {f}_{k} {t}_{3} + Δ {θ}_{k} )}}}_{CFO and PO} \times {s}_{k} {e}^{j {θ}_{2}} \\ = {θ}_{desired} + 2 π Δ {f}_{k} ( {t}_{2} - {t}_{3} + {t}_{1} - {t}_{0} ) + {θ}_{u , k}^{′} - {θ}_{u , k} + {θ}_{d , k}^{′} - {θ}_{d , k} + \\ ∠ {s}_{k} \\ \approx {θ}_{desired} + ∠ {s}_{k} ,\end{matrix}$$

where the approximation holds for

$$Δ {f}_{k} ( {t}_{2} - {t}_{3} + {t}_{1} - {t}_{0} ) \approx 0 ( e . g . , 360 ° \times 25 Hz \times 500 μs = 4.5 ° ) ,$$

$${θ}_{u , k}^{′} \approx {θ}_{u , k} , and {θ}_{d , k}^{′} \approx {θ}_{d , k} .$$

The procedure above considers a single OFDM subcarrier or narrowband single-carrier waveform. However, it may be generalized or modified to a multi-carrier transmission by parallelizing the procedure in the frequency domain.

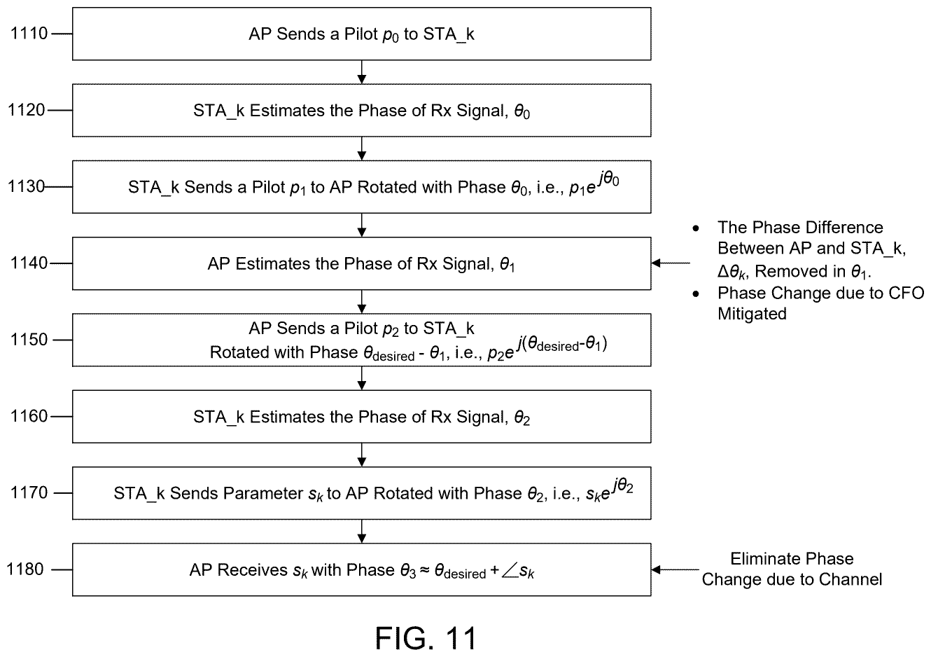

FIG. 11 illustrates a flowchart of a method for the phase alignment procedure with phase-coded pilots, according to certain embodiments. As illustrated in the example of FIG. 11, at 1110, the AP may send a pilot symbol (p₀) to a STA (e.g., STA k) as discussed above with respect to FIG. 10 (e.g., procedure 1010). At 1120, the STA (e.g., STA k) may estimate the phase change of the signal received in the downlink (e.g., as discussed with respect to FIG. 10 at 1010).

As also illustrated in the example of FIG. 11, at 1130, the STA (e.g., STA k) may send, to the AP, a pilot that is phase coded based on the estimated phase change (e.g., pilot symbol rotated with Phase θ₀, i.e., p₁e^{jθ0}). At 1140, the AP may estimate the phase change of the signal received in the uplink as discussed above with respect to FIG. 10 (e.g., procedure 1020).

In the example of FIG. 11, at 1150, the AP may send a pilot (p₂) to the STA (e.g., STA k) that is phase-coded based on the estimated phase change at 1140 (e.g., pilot (p₂) is rotated with Phase θ_{desired}−θ₁. At 1160, the STA (e.g., STA k) may estimate the phase of the received phase-coded signal as discussed above with respect to FIG. 10 (e.g., procedure 1030).

As further illustrated in the example of FIG. 11, at 1170, the STA (e.g., STA k) may send, to the AP, a phase-coded parameter (sₖ) (e.g., parameter rotated with phase θ₂). At 1180, the AP may receive the signal with phase change eliminated due to channel as discussed above with respect to FIG. 10 (e.g., procedure 1040). In other words, the phase of the received signal is aligned with the desired or target phase θ_{desired}.

Some embodiments may include phase and amplitude alignment procedure with phase-coded pilots. In one embodiment, an additional phase term may be introduced to the phase-coded pilots to aggregate the scaled real-valued parameters for each STA to achieve amplitude alignment across the network.

To this end, considering the procedure described above with respect to FIGS. 10 and 11, let S be a real-valued parameter (e.g., gradients) and a_{desired}>0 denote a non-negative scale parameter for adjusting the amplitude of the received sₖ at the AP side. Without loss of generality, let θ_{desired} be zero radian for simpler exposition. The procedure may be the same or similar as the one described with respect to FIG. 10, except for modifications to 1030 and 1040 as follows.

In 1030, (t=t₂), as a response to the pilot signal received in 1020, the AP may transmit a phase-coded signal as a function of the amplitude change in the kth STA's uplink channel, i.e., θ_{corr,k}, and the estimated phase change, i.e., θ₁, in 1020 as:

$${x}_{d} ( {t}_{0} ) = {p}_{2} {e}^{j {θ}_{c o r r , k} - j {θ}_{1}} ,$$

where θ_{corr,k} is the amplitude correction term and is calculated as:

$${θ}_{corr , k} = {cos}^{- 1} ( \frac{{a}_{desired}}{{a}_{u , k}} ) ,$$

Thus, the received signal at the kth STA can be expressed as:

$${r}_{d , k} ( {t}_{2} ) = {{\underbrace{{a}_{d , k}^{′} {e}^{j {θ}_{d , k}^{′}}}}_{downlink}}_{channel} \times {\underbrace{{e}^{j ( 2 π Δ {f}_{k} {t}_{2} + Δ {θ}_{k} )}}}_{CFO and PO} \times {p}_{2} {e}^{j ( {θ}_{corr , k} - {θ}_{1} )} .$$

The kth STA may then estimate the phase change in the downlink channel as:

$$\begin{matrix}{θ}_{2} = ∠ \frac{{r}_{d , k} ( {t}_{2} )}{{p}_{2}} = ∠ {{\underbrace{{a}_{d , k}^{′} {e}^{j {θ}_{d , k}^{′}}}}_{downlink}}_{channel} \times {\underbrace{{e}^{j ( 2 π Δ {f}_{k} {t}_{2} + Δ {θ}_{k} )}}}_{CFO and PO} \times {e}^{j ( {θ}_{corr , k} - {θ}_{1} )} \\ = {θ}_{corr , k} + 2 π Δ {f}_{k} ( {t}_{2} + {t}_{1} - {t}_{0} ) - {θ}_{u , k} + {Δθ}_{k} + {θ}_{d , k}^{′} - {θ}_{d , k} .\end{matrix}$$

At 1040, For coherent aggregation, the kth STA may transmit a phase-coded parameter sₖ to be aggregated, i.e., x_{u,k}(t₃)=sₖe^{jθ}^{₂}. Thus, the phase of the received signal at the AP can be expressed as:

$$\begin{matrix}{θ}_{3} = ∠ {r}_{u , k} ( {t}_{3} ) = ∠ {{\underbrace{{a}_{u , k}^{′} {e}^{j {θ}_{u , k}^{′}}}}_{uplink}}_{channel} \times {\underbrace{{e}^{- j ( 2 π Δ {f}_{k} {t}_{3} + Δ {θ}_{k} )}}}_{CFO and PO} \times {s}_{k} {e}^{j {θ}_{2}} \\ = {θ}_{corr , k} + 2 π Δ {f}_{k} ( {t}_{2} - {t}_{3} + {t}_{1} - {t}_{0} ) + {θ}_{u , k}^{′} - {θ}_{u , k} + {θ}_{d , k}^{′} - {θ}_{d , k} \\ + {{\underbrace{∠ {s}_{k}}}_{= 0 radian as it is}}_{a real - valued parameter} \approx {θ}_{corr , k} ,\end{matrix}$$

where the approximation holds for

$$Δ {f}_{k} ( {t}_{2} - {t}_{3} + {t}_{1} - {t}_{0} ) \approx 0 , {θ}_{u , k}^{′} \approx {θ}_{u , k} , and {θ}_{d , k}^{′} \approx {θ}_{d , k} .$$

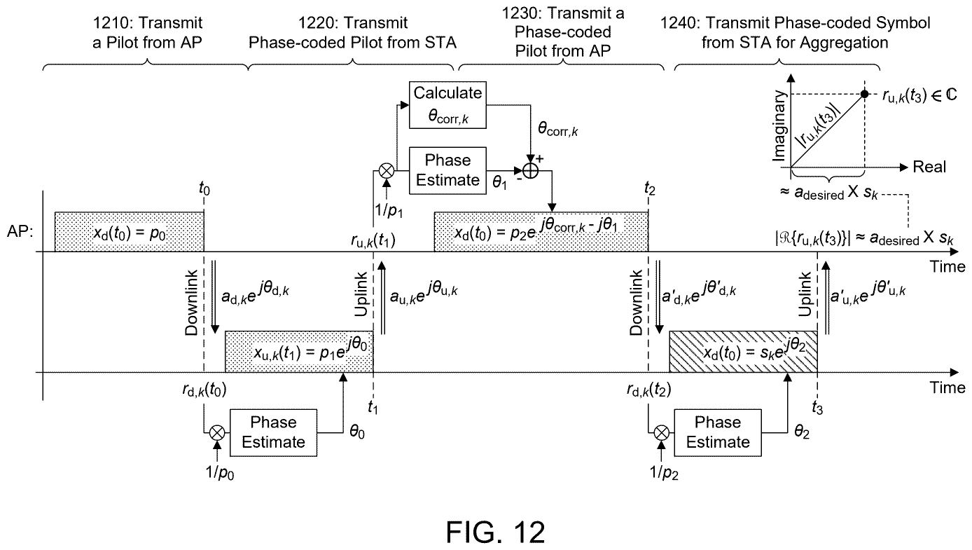

The receiver AP then obtains the real part of r_{u,k}(t₃), as shown in FIG. 12. Notice that the real part of r_{u,k}(t₃) approximately has the desired amplitude because:

$$ℜ \{ {r}_{u , k} ( {t}_{3} ) \} = \vert {r}_{u , k} ( {t}_{3} ) \vert cos ( ∠ {r}_{u , k} ( {t}_{3} ) ) \approx {s}_{k} {a}_{u , k}^{′} cos ( {θ}_{corr , k} ) \approx {s}_{k} {a}_{u , k}^{′} \frac{{a}_{desired}}{{a}_{u , k}} \approx {a}_{d e s i r e d} \times {s}_{k} .$$

Thus, the AP scales sₖ with a_{desired} regardless of the value of a_{u,k}, effectively.

FIG. 12 illustrates an example diagram of amplitude alignment procedure with phase-coded pilots while maintaining phase alignment, according to certain embodiments. Similar to FIG. 10, the procedure of FIG. 12 may include the AP transmitting a pilot at 1210, the STA transmitting a phase-coded pilot at 1220, the AP transmitting a phase-coded pilot at 1230, and the STA transmitting a phase-coded symbol for aggregation at 1240. The example of FIG. 12 shows how the phase-coded pilots are used for achieving coherent aggregation while maintaining a desired amplitude. This method may be used to align the amplitude of the STA's parameters at the AP side for OAC, leading to

$${a}_{d e s i r e d} {\sum }_{k = 1}^{K} {s}_{k}$$

during the aggregation phase. The main advantage of this method is that the STAs do not change their transmit powers to achieve amplitude alignment across the network. It is noted that this method may assume that sₖ is real-valued parameter (e.g., a gradient value), which is typical for many applications.

In some examples, it may be assumed that θ_{desired}=0 radians. Thus, the AP may perform the aggregation on the real axis of the complex plain. If an additional desired phase term is introduced to the procedure, the AP may perform the aggregation on the line where its slope is defined by θ_{desired} (i.e., by projecting r_{u,k}(t₃) on the line defined by θ_{desired}).

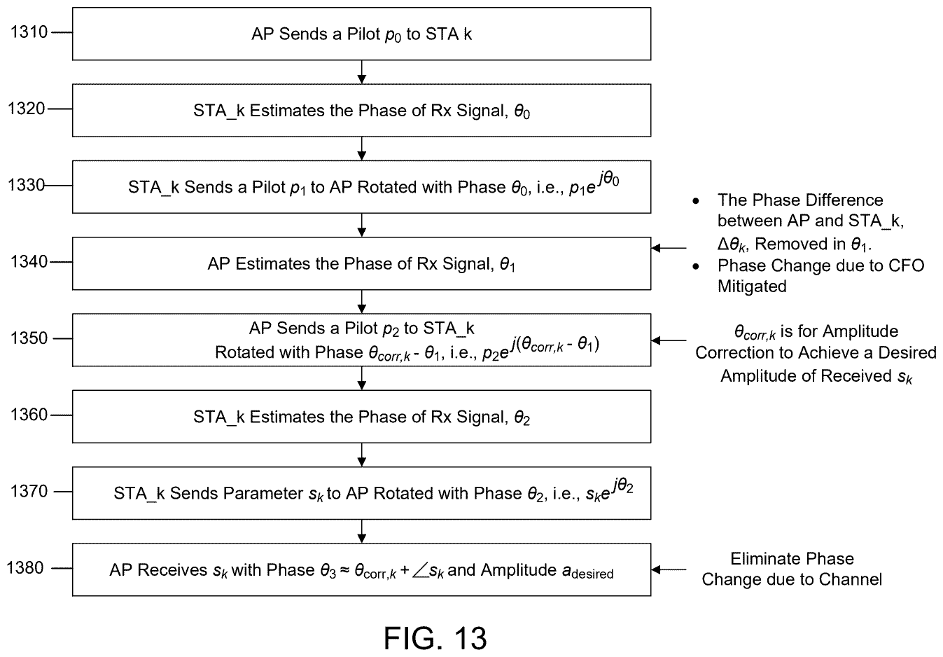

FIG. 13 illustrates a flowchart of a method for a phase and amplitude alignment procedure with phase-coded pilots, according to certain embodiments. As illustrated in the example of FIG. 13, at 1310, the AP may send a pilot symbol (p₀) to a STA (e.g., STA k) as discussed above with respect to FIG. 12 (e.g., procedure 1210). At 1320, the STA (e.g., STA k) may estimate the phase change of the signal received in the downlink (e.g., as discussed with respect to FIG. 12 at 1210).

As also illustrated in the example of FIG. 13, at 1330, the STA (e.g., STA k) may send, to the AP, a pilot that is phase coded based on the estimated phase change (e.g., pilot symbol rotated with Phase θ₀, i.e., p₁e^{jθ0}). At 1340, the AP may estimate the phase change of the signal received in the uplink as discussed above with respect to FIG. 12 (e.g., procedure 1220).

In the example of FIG. 13, at 1350, the AP may send a pilot (p₂) to the STA (e.g., STA k) that is phase-coded based on the estimated phase change at 1340, e.g., pilot (p₂) is rotated with Phase θ_{corr,k}−θ₁, i.e., p₂e. At 1360, the STA (e.g., STA k) may estimate the phase of the received phase-coded signal as discussed above with respect to FIG. 12 (e.g., procedure 1230).

As further illustrated in the example of FIG. 13, at 1370, the STA (e.g., STA k) may send, to the AP, a phase-coded parameter (sₖ) (e.g., parameter rotated with phase 02). At 1380, the AP may receive the signal with phase θ₃≈θ_{corr,k}+sₖ and amplitude a_{desired} as discussed above with respect to FIG. 12 (e.g., procedure 1240). In other words, the phase change due to channel is eliminated and the amplitude is aligned with the desired or target amplitude.

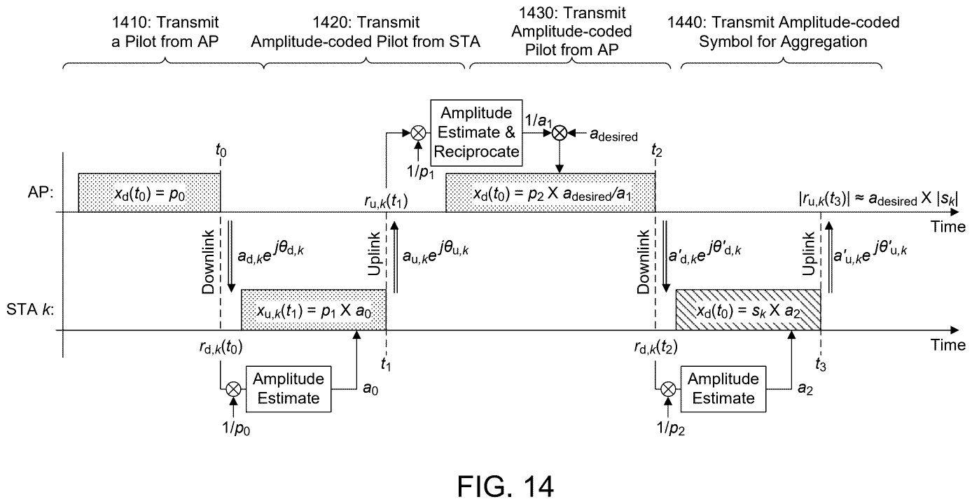

Certain embodiments may include amplitude alignment procedure with amplitude-coded pilots. FIG. 14 illustrates a diagram depicting an amplitude alignment procedure with amplitude-coded pilots, according to some embodiments. In one embodiment, the AP and the kth STA can exchange amplitude-coded pilots in the downlink and uplink directions to scale the amplitude of the received signal from kth STA to achieve amplitude alignment across the network. To this end, let a_{desired}>0 denote a non-negative scale parameter for adjusting the amplitude of the received sₖ from the kth STA at the AP side, taking into account the mathematical model introduced above.

As illustrated in the example of FIG. 14, at 1410 (t=t₀), the AP may transmit a pilot symbol, e.g., x_{d}(t₀)=p₀, e.g., p₀=1. Thus, the received signal at the kth STA can be expressed as:

$${r}_{d , k} ( {t}_{0} ) = {{\underbrace{{a}_{d , k} {e}^{j {θ}_{d , k}}}}_{downlink}}_{channel} \times {\underbrace{{e}^{j ( 2 πΔ {f}_{k} {t}_{0} + {Δθ}_{k} )}}}_{CFO and PO} \times {p}_{0} .$$

Furthermore, the kth STA may estimate the amplitude change in the downlink channel as:

$${a}_{0} = \vert \frac{{r}_{d , k} ( {t}_{0} )}{{p}_{0}} \vert = \vert {{\underbrace{{a}_{d , k} {e}^{j {θ}_{d , k}}}}_{downlink}}_{channel} \times {\underbrace{{e}^{j ( 2 πΔ {f}_{k} {t}_{0} + {Δθ}_{k} )}}}_{CFO and PO} \vert = {a}_{d , k} .$$

In the example of FIG. 14, at 1410 (t=t₁), as a response to the pilot signal received in 1410, the kth STA may transmit an amplitude-coded pilot, i.e., x_{u,k}(t₁)=p₁×a₀, based on the estimated amplitude change, i.e., a₀, in 1410. Thus, the received signal at the AP can be expressed as:

$${r}_{u , k} ( {t}_{1} ) = {{\underbrace{{a}_{u , k} {e}^{j {θ}_{u , k}}}}_{uplink}}_{channel} \times {\underbrace{{e}^{- j ( 2 π Δ {f}_{k} {f}_{1} + Δ {θ}_{k} )}}}_{CFO and PO} \times {p}_{1} \times {a}_{0} .$$

The AP then may estimate the amplitude change in the uplink channel as:

$${a}_{1} = \vert \frac{{r}_{u , k} ( {t}_{1} )}{{p}_{1}} \vert = \vert {{\underbrace{{a}_{u , k} {e}^{j {θ}_{u , k}}}}_{uplink}}_{channel} \times {\underbrace{{e}^{- j ( 2 π Δ {f}_{k} {f}_{1} + Δ {θ}_{k} )}}}_{CFO and PO} \times {a}_{0} \vert = {a}_{u , k} \times {a}_{d , k} .$$

Thus, the AP estimates round-trip amplitude change in this step due to the fading channel.

As illustrated in the example of FIG. 14, at 1430 (t=t₂), as a response to the pilot signal received in 1420, the AP may transmit an amplitude-coded pilot, i.e.,

$${x}_{d} ( {t}_{0} ) = {p}_{2} \times \frac{{a}_{d e s i r e d}}{{a}_{1}} ,$$

based on the reciprocal of the estimated amplitude change, i.e., 1/a₁, in 1420 and the desired amplitude term, i.e., a_{desired}. Thus, the received signal at the kth STA can be expressed as:

$${r}_{d , k} ( {t}_{2} ) = {{\underbrace{{a}_{d , k}^{′} {e}^{j {θ}_{d , k}^{′}}}}_{downlink}}_{channel} \times {\underbrace{{e}^{j ( 2 π Δ {f}_{k} {t}_{2} + Δ {θ}_{k} )}}}_{CFO and PO} \times {p}_{2} \times \frac{{a}_{d e s {i}_{Γ} e d}}{{a}_{1}} ,$$

where

$${a}_{d , k}^{′} and {θ}_{d , k}^{′}$$

denote the amplitude and phase response in the downlink multipath channel, respectively. The kth STA may then estimate the amplitude change in the downlink channel as:

$$\begin{matrix}{a}_{2} = \vert \frac{{r}_{d , k} ( {t}_{2} )}{{p}_{2}} \vert = \vert {{\underbrace{{a}_{d , k}^{′} {e}^{j {θ}_{d , k}^{′}}}}_{downlink}}_{channel} \times {\underbrace{{e}^{j ( 2 π Δ {f}_{k} {t}_{2} + Δ {θ}_{k} )}}}_{CFO and PO} \times \frac{{a}_{desired}}{{a}_{1}} \vert = {a}_{d , k}^{′} \times \frac{{a}_{desired}}{{a}_{1}} \\ = {a}_{d , k}^{′} \times \frac{{a}_{desired}}{{a}_{u , k} \times {a}_{d , k}}\end{matrix} .$$

In the example of FIG. 14, at 1440 (t=t₃), the kth STA may transmit an amplitude-coded parameter sₖ to be aggregated, i.e., x_{u,k}(t₃)=sₖ×a₂ based on the estimate of the amplitude change in the downlink channel in 1430, i.e., a₂. Thus, the received signal at the AP can be expressed as:

$${r}_{u , k} ( {t}_{3} ) = {{\underbrace{{a}_{u , k}^{′} {e}^{j {θ}_{u , k}^{′}}}}_{uplink}}_{channel} \times {\underbrace{{e}^{- j ( 2 π Δ {f}_{k} {t}_{3} + Δ {θ}_{k} )}}}_{CFO and PO} \times {s}_{k} \times {a}_{2} .$$

Thus, the amplitude of the received signal is aligned with the desired or target amplitude a_{desired}:

$$\begin{matrix}{a}_{3} = \vert {r}_{u , k} ( {t}_{3} ) \vert = {{\underbrace{{a}_{u , k}^{′} {e}^{j {θ}_{u , k}^{′}}}}_{uplink}}_{channel} \times {\underbrace{{e}^{- j ( 2 π Δ {f}_{k} {f}_{3} + Δ {θ}_{k} )}}}_{CFO and PO} \times {s}_{k} \times {a}_{2} = {a}_{u , k}^{′} \times {a}_{2} \\ = \frac{{a}_{u , k}^{′} \times {a}_{d , k}^{′}}{{a}_{u , k} \times {a}_{d , k}} \times {a}_{desired} \times \vert {s}_{k} \vert \approx {a}_{desired} \times \vert {s}_{k} \vert\end{matrix} ,$$

as

$${a}_{u , k}^{′} \approx {a}_{u , k} and {a}_{d , k}^{′} \approx {a}_{d , k} .$$

These approximations hold because the change of the fading coefficients due to the mobility in the environment is negligibly small in practice, given the small pilot exchange duration of this procedure.

It is noted that the amplitude-coded pilots may be used with the phase-coded pilots, i.e., the method discussed above, to achieve both amplitude and phase alignment simultaneously in the network.

Compared to the method discussed above with respect to FIGS. 12 and 13, this method alters the transmit power. However, it may utilize the transmission power better in frequency-selective (wideband) channels. Also, it allows sₖ to be a complex-valued parameter in general. Therefore, sₖ can encode two real-valued parameters (e.g., two gradient values), i.e., a higher computation rate.

Certain embodiments may include alignment procedures for multiple STAs. For example, the alignment procedures described above may be generalized to the case with multiple STAs by applying it for each STA sequentially and/or in parallel (or some combination) by exploiting the coherence bandwidth of the wireless channel.

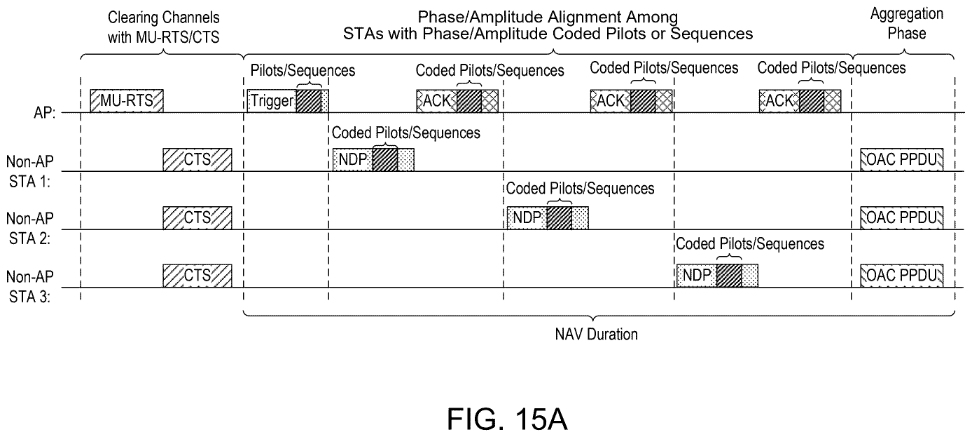

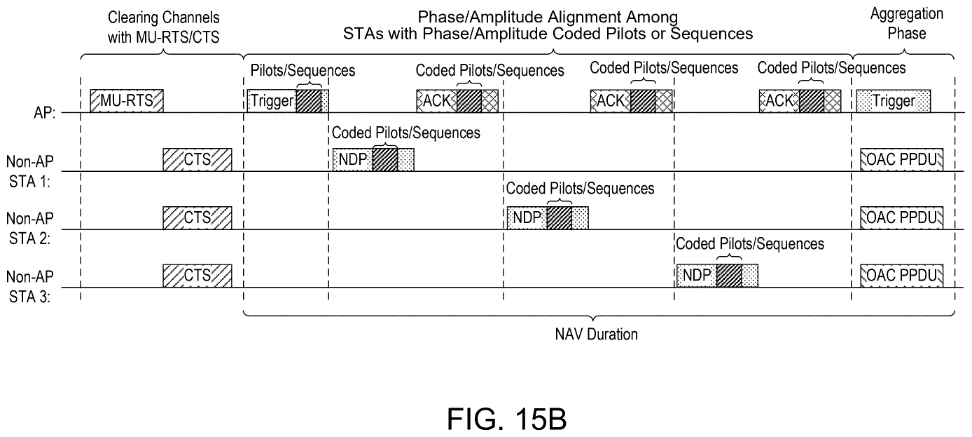

In one embodiment, the alignment procedures may be performed sequentially and the phase/amplitude-coded pilots are cascaded in the time domain, as shown in FIG. 15A for three non-AP STAs. In particular, FIG. 15A illustrates an example sequential phase and amplitude alignment with phase/amplitude coded pilots (e.g., for 3 STAs in this example, but could be any number of STAs), according to some embodiments.

As illustrated in the example of FIG. 15A, the AP may first transmit (e.g., as part of preparation) a multi-user-request-to-send (MU-RTS) signal or other triggering signals for the corresponding non-AP STAs and set the NAV duration during the alignment and aggregation phases. As a response to the MU-RTS signal, the non-AP STA may transmit a clear-to-send (CTS) signal or other types of triggering signals to clear the channel. The NAV duration may include both the aggregation phase and the alignment phase.

As illustrated in the example of FIG. 15A, the AP may transmit (e.g., as part of alignment) a trigger frame to trigger one or multiple STAs to transmit NDPs in the uplink with the phase-coded pilots or sequences on the corresponding regular resource units (RRUs) or distributed resource units (DRUs) based on the RRUs and DRUs used during the aggregation phase. While an RRU implies a set of contiguous set of subcarriers, a DRU means a set of subcarriers where the subcarrier indices are distributed across the bandwidth. The trigger frame may also include any one or more of the following parameters: STA IDs or indices to set which STAs will be part of the OAC during the aggregation phase, the target received signal power during the aggregation phase, the transmit power of the PPDU carrying the triggering frame (STAs may calculate the path loss and determine its transmission power with transmit power and desired received power information), the number of stations participating in OAC, the desired phase value θ_{desired} or multiple values, a threshold to avoid unintentional power boosting in case the amplitude alignment requires a large gain, the time of the start and finish of the OAC PPDU, the length/duration of the OAC PPDU, and/or the resources used for OAC during the aggregation phase (explicit).

Note that, in in some embodiments, the resources (DRUs or RUs) used for alignment may be identical to the resources used in aggregation (implicit). The trigger frame may explicitly include or assign numbers to each STA to indicate the order of the STAs during the sequential phase.

Upon receiving the trigger frame, the non-AP STAs (e.g., all non-AP STAs) may first adjust their transmit powers and apply pre-compensation for the CFO to ensure the reliability of the phase and aggregation phases. Specifically, when it is the kth STA turn, the kth STA may apply one or more of the step(s) of the alignment procedures described above (e.g., step 1120/1130 of FIG. 11, step 1320/1330 of FIG. 13) based on coded pilots. The AP may apply one or more of the step(s) of the alignment procedures described above (e.g., step 1140/1150 of FIG. 11, step 1340/1350 of FIG. 13) based on coded pilots and transmit an ACK signal. The kth STA may wait for the aggregation phase to transmit a PPDU for OAC.

In certain embodiments, the alignment phase may continue until all non-AP STAs derive their correction parameters for the aggregation phase sequentially.

As illustrated in the example of FIG. 15A, once non-AP STAs derive their correction parameters, the STAs transmit OAC PPDU simultaneously on the dedicated RUs or DRUs. It is noted that there may be another trigger frame from the AP to trigger all non-AP STAs to send their OAC PPDUs simultaneously, as shown in the example of FIG. 15B. In particular, FIG. 15B illustrates an example sequential phase and amplitude alignment with phase/amplitude coded pilots with an additional trigger frame for triggering aggregation (e.g., for 3 STAs in this example, but could be any number of STAs), according to some embodiments.

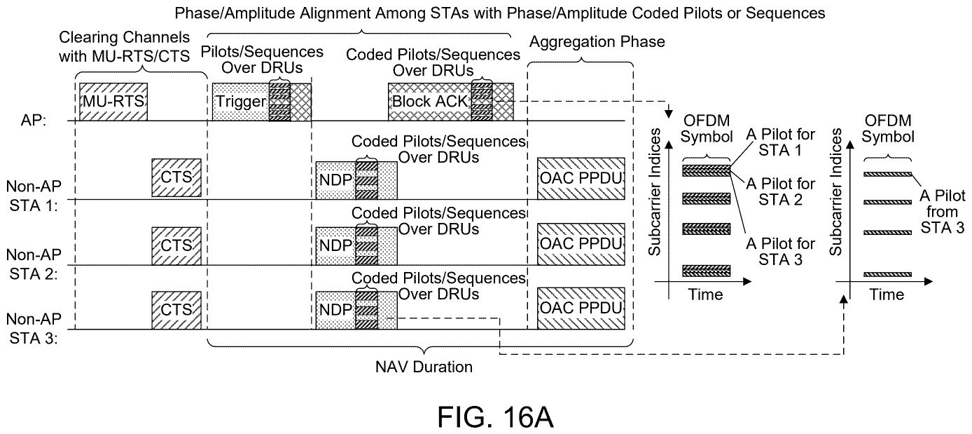

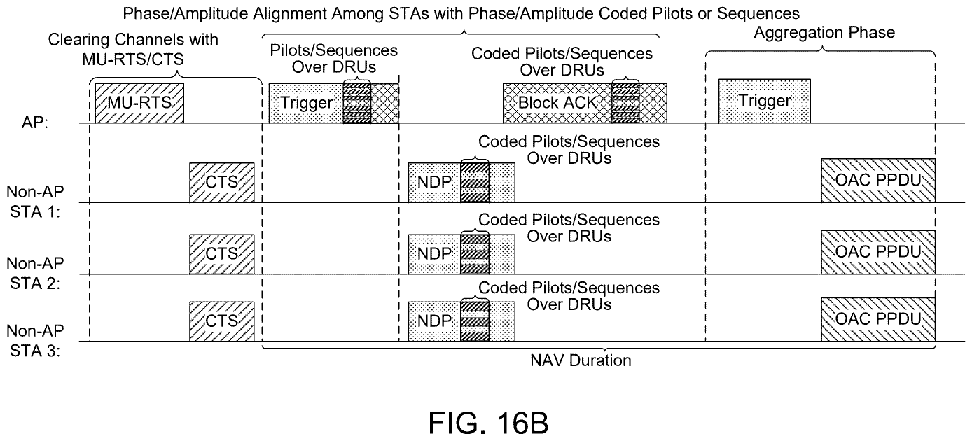

As mentioned above, certain embodiments may apply a parallel method of alignment. The sequential method may cause a long alignment phase as it linearly scales with the number of non-AP STAs. To address this issue, DRUs may be used to reduce the duration of the alignment phase by exploiting the coherence bandwidth. Note that the channel frequency response (CFR) changes smoothly as a function of the frequency in practice, and the maximum bandwidth where the CFR is relatively unchanged (or highly correlated) is called coherence bandwidth. FIG. 16A illustrates an example of parallel phase and amplitude alignment with phase/amplitude coded pilots (e.g., for 3 STAs in this example, but could be any number of STAs), according to some embodiments.

As shown in the example of FIG. 16A, the AP may first transmit (e.g., as part of preparation) a multi-user-request-to-send (MU-RTS) signal for the corresponding non-AP STAs and set the NAV duration during the alignment and aggregation phases. In response to the MU-RTS signal, the non-AP STA may transmit a clear-to-send (CTS) signal to clear the channel. The NAV duration may include both the aggregation phase and the alignment phase.

As illustrated in the example of FIG. 16A, the AP may transmit (e.g., as part of alignment) a trigger frame to trigger one or multiple STAs, and STAs transmit NDPs in uplink with phase-coded pilots or sequences on the several distributed resource units (DRUs), where (1) the corresponding DRUs may be dedicated for the K STAs in an interlaced manner where kth STA uses one of the dedicated DRUs for the alignment, and/or (2) the total bandwidth used for the DRUs (i.e., the distribution bandwidth of the DRUs) used for alignment may span to the DRUs used in aggregation (i.e., implicit information on aggregation resources). According to some embodiments, the trigger frame may include any one or more of the following parameters: STA IDs or indices to set which STAs will be part of the OAC during the aggregation phase, the target received signal power during the aggregation phase, the transmit power of the PPDU carrying the triggering frame (STAs may calculate the path loss and determine its transmission power with transmit power and desired received power information), the number of stations participating in OAC, a threshold to avoid unintentional power boosting in case the amplitude alignment requires a large gain, the time of the start and finish of the OAC PPDU, the length/duration of the OAC PPDU, the resources used for OAC during the aggregation phase (explicit). The trigger frame may explicitly include or assign indices to STAs and indicate which DRUs are dedicated to which STA for the alignment procedure.

Upon receiving the trigger frame, non-AP STAs (e.g., all non-AP STAs) may first adjust their transmit powers and apply pre-compensation for the CFO to ensure the reliability of the phase and aggregation phases. Specifically, the kth non-AP STA may apply one or more of the step(s) of the alignment procedures described above (e.g., step 1120/1130 of FIG. 11, step 1320/1330 of FIG. 13) based on coded pilots located its own DRUs. The AP may apply one or more of the step(s) of the alignment procedures described above (e.g., step 1140/1150 of FIG. 11, step 1340/1350 of FIG. 13) for all non-AP STAs over the DRUs and transmit a block ACK signal for non-AP STAs.

As shown in the example of FIG. 16A, (e.g., for aggregation) once the non-AP STAs derive their correction parameters, the STAs transmit OAC PPDU simultaneously on all the dedicated DRUs. Similar to the sequential method, there may be another trigger frame from the AP to trigger all non-AP STAs to send the OAC PPDUs simultaneously, as shown in the example of FIG. 16B. In particular, FIG. 16B illustrates an example of parallel phase and amplitude alignment with phase/amplitude coded pilots with an additional trigger frame for triggering aggregation (for 3 STAs in this example, but could be any number of STAs), according to some embodiments.

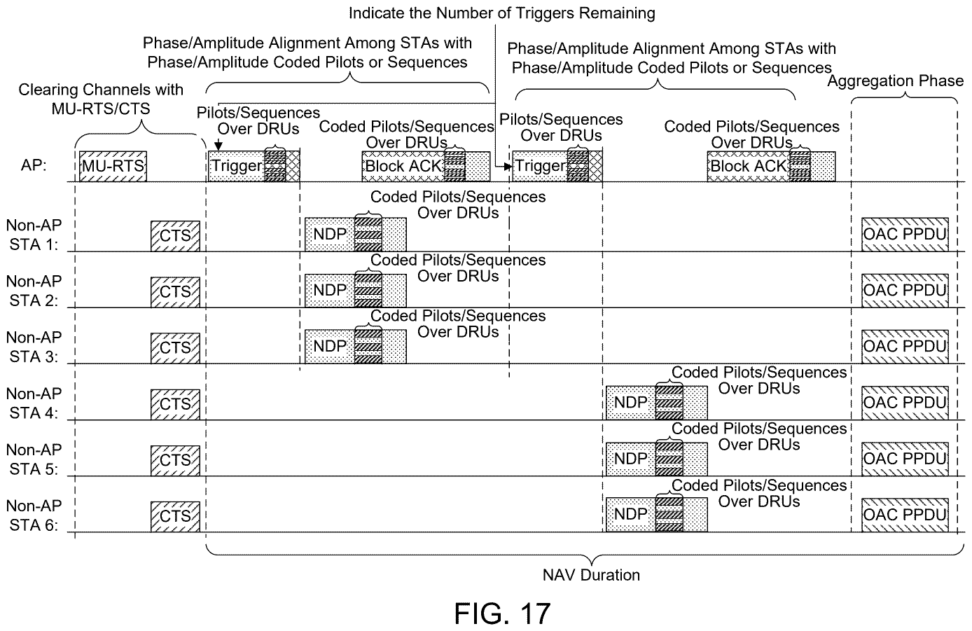

Some embodiments may apply a parallel-sequential hybrid method for alignment. In some scenarios, there may be many non-AT STAs as EDs, and the frequency resources may not be sufficient for the parallel-only method mentioned above. A hybrid method that uses both the aforementioned sequential and parallel methods may be utilized to address this issue. In this method, the non-AP STAs may be partitioned into several groups (e.g., two or more groups). While the sequential method is used across the groups, the parallel method is employed for the non-AP STAs in each group. FIG. 17 illustrates an example parallel-sequential hybrid phase and amplitude alignment with phase/amplitude coded pilots, according to some embodiments. The example of FIG. 17 demonstrates the concept in which six non-AP STAs are partitioned into two groups, i.e., {STA1, STA2, STA3} and {STA4, STA5, STA6}. In this example, the parallel method is used for the group {STA1, STA2, STA3} and the group {STA4, STA5, STA6}, sequentially.

The information in the triggered frame may be the same as the one for the aforementioned parallel method. The trigger frame may include extra information about the hybrid method including any one or more of: an indication of the total number of trigger PPDUs, the number of remaining trigger PPDUs, a group index, number of groups, and/or STA indices within the group.

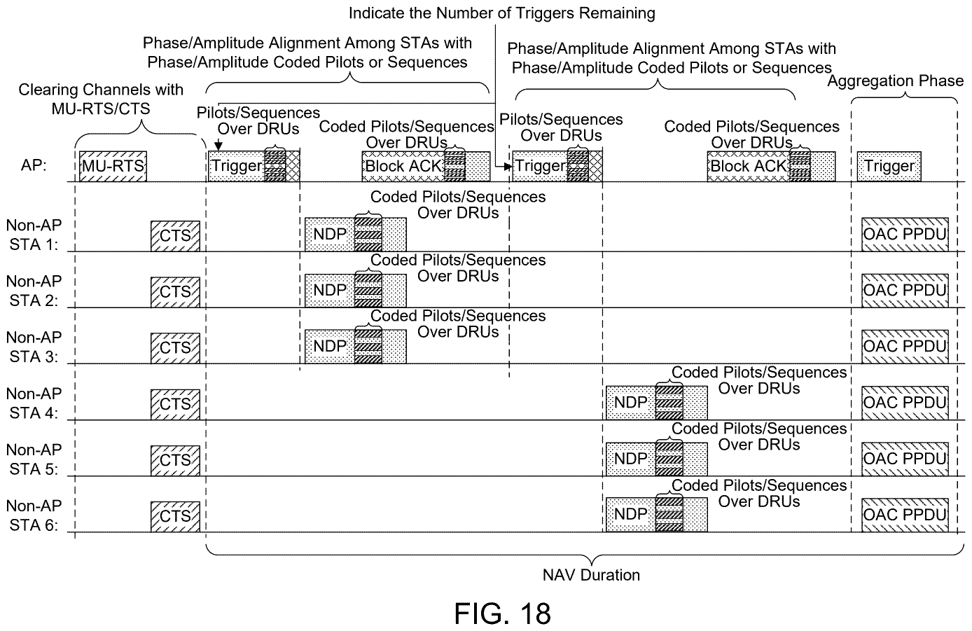

FIG. 18 illustrates an example parallel-sequential hybrid phase and amplitude alignment with phase/amplitude coded pilots with an additional trigger frame for triggering aggregation, according to some embodiments. In this example, another trigger frame may be transmitted from AP before OAC PPDU transmissions from non-AP STAs, as shown in FIG. 18.

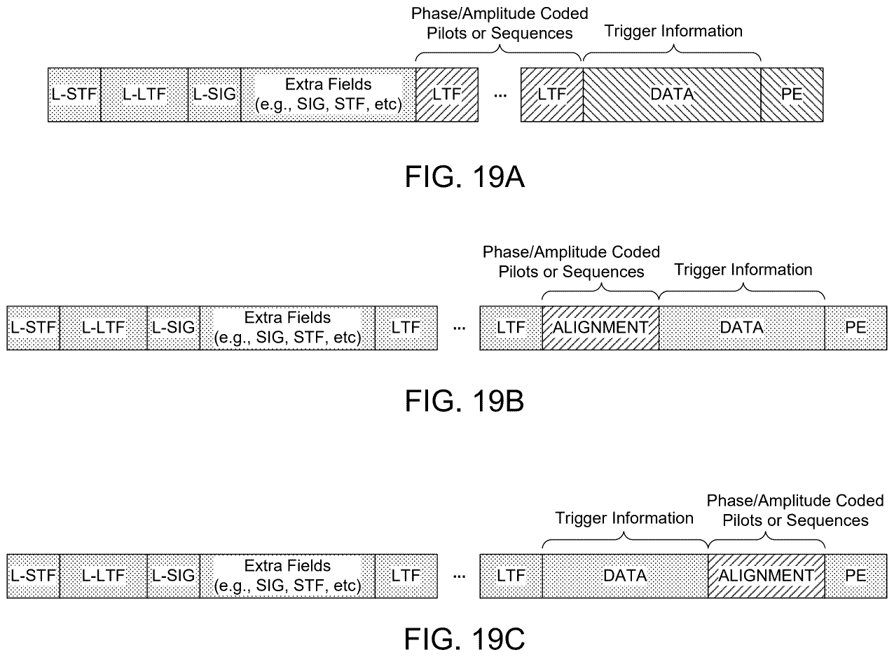

For the aforementioned parallel, sequential, and hybrid methods, a trigger-based PPDU, a null-data packet (NDP), and a block ACK may need to be transmitted from AP and/or non-AP STAs. FIG. 19A, FIG. 19B, and FIG. 19C illustrate examples of PPDU structures for trigger-based PPDU with phase/amplitude coded pilots or sequences, according to certain embodiments. The structure of the trigger-based (TB) PPDU for achieving phase and amplitude synchronization may be based on any of FIGS. 19A-19C.

In one approach, as shown in FIG. 19A, an element of the sequence used in long-training field (LTF) of the TB PPDU may be a phase/amplitude-coded pilot as in FIG. 19A. Since LTF is also used for channel estimation at the STAs, the data and packet extension fields may also be encoded with the same phase and amplitude information in phase/amplitude-coded pilots.

In one approach, as shown in FIG. 19B, a specific field for phase/amplitude synchronization with the phase/amplitude coded pilots (ALIGNMENT field) may be transmitted after a long-training field (LTF) of the TB PPDU, and this field may include the phase/amplitude coded pilots as shown in FIG. 19B. Since ALIGNMENT is a dedicated field, this approach does not encode the DATA and packet extension (PE) fields.

In one approach, as shown in FIG. 19C, a specific field for alignment purposes (ALIGNMENT) may be transmitted after a data field of the TB PPDU. This field may include the phase/amplitude-coded pilots, as shown in FIG. 19C. Since this is a dedicated field, the DATA and PE fields are not encoded in this approach. This structure is useful for mitigating phase drifts due to the residual CFO by reducing the duration between the sounding and aggregation phases.

The structure of the NPD phase and amplitude synchronization with phase/amplitude coded pilots may be similar to TB-PPDU in FIG. 19C, except that it may not include a data field.

For block ACK, structures of any of FIGS. 19A-19C may be used for block ACK transmission, where the DATA field may include a block-ACK frame, i.e., a multi-used PPDU.

The aforementioned PPDU structure may include distributed resource units (DRUs) or regular resource units (RRUs).

Some embodiments may include alignment procedures based on explicit channel feedback. In certain embodiments, the AP may explicitly provide the UL channel state information to align the phases and amplitude of the signals transmitted from all STA on the AP side. A sequential, parallel, or parallel-sequential hybrid method may be used according to certain embodiments, as discussed in the following.

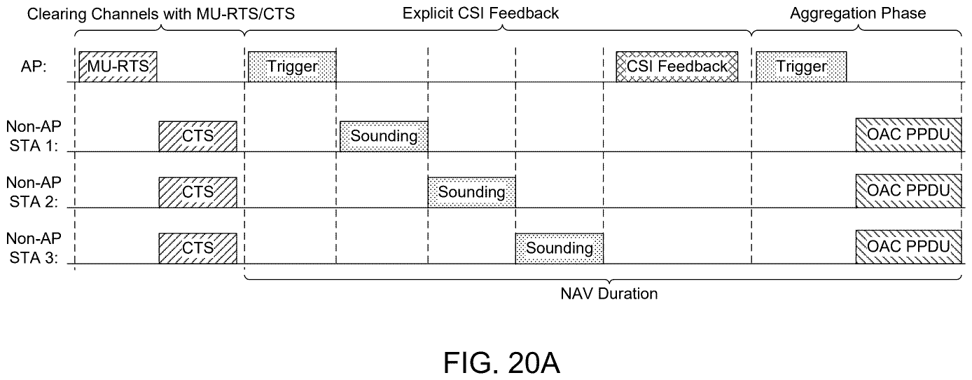

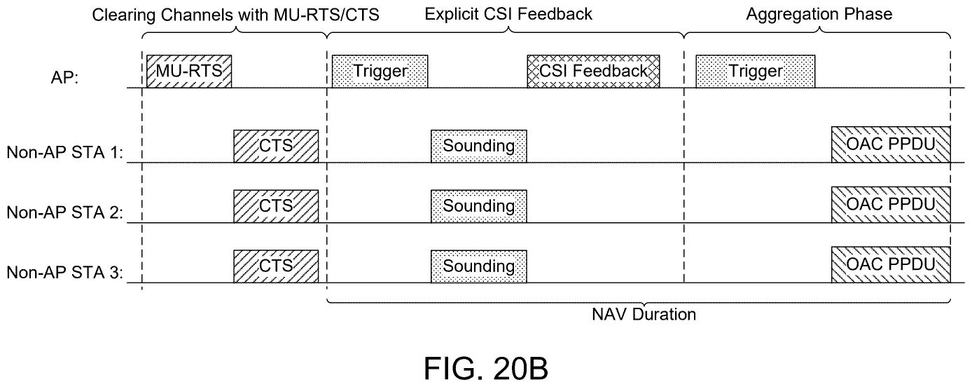

FIG. 20A illustrates an example of a sequential method, according to certain embodiments. As illustrated in the example of FIG. 20A, the AP may first transmit (e.g., as part of preparation) a multi-user-request-to-send (MU-RTS) signal or other types of triggering signals for the corresponding non-AP STAs and set the NAV duration during the alignment phase and aggregation phase. In response to the MU-RTS signal, the non-AP STA may transmit a clear-to-send (CTS) signal or other triggering signals to clear the channel. The NAV duration may include both the aggregation phase and the alignment phase.

As illustrated in the example of FIG. 20A, the AP may transmit a trigger frame (e.g., as part of UL sounding for alignment) to trigger one or multiple STAs to transmit sounding PPDUs (e.g., NDP PPDU) in uplink on the corresponding regular resource units (RRUs) or distributed resource units (DRUs) based on the RRUs and DRUs used during the aggregation phase. The trigger frame may also include the parameters and/or information (e.g., resources used for alignment and aggregation) discussed above.

Upon receiving the trigger frame, all non-AP STAs may first adjust their transmit powers and apply pre-compensation for the CFO to ensure the reliability of the phase and aggregation phases. Specifically, when it is the kth STA turn, the kth STA may transmit a sounding PPDU, e.g., an NDP PPDU, and/or the kth STA waits for the aggregation phase to transmit a PPDU for aggregation.

The exchanges between AP and non-AP STAs for UL sounding may continue till all non-AP STAs transmit a sounding PPDU sequentially. Once AP receives the sounding PPDUs from STAs, it derives the UL CSI for each STA and transmits a PPDU that contains the CSI for all non-AP STAs. Once a non-AP STA obtains its CSI, it computes the correction parameters (e.g., reciprocal of the channel frequency response coefficients, conjugate of the channel frequency response) for alignment during the aggregation phase.

As illustrated in the example of FIG. 20A, the AP may transmit a trigger frame (e.g., as part of aggregation) to trigger all non-AP STAs to send the OAC PPDUs simultaneously, as shown in FIG. 20A. Note that the trigger frame may be omitted in one method, and OAC PPDU may start after receiving CSI feedback.

FIG. 20B illustrates an example of a parallel method, according to certain embodiments. As illustrated in the example of FIG. 20B, the AP may first transmit (e.g., as part of preparation) a multi-user-request-to-send (MU-RTS) signal or other types of triggering signals for the corresponding non-AP STAs and set the NAV duration during the alignment phase and aggregation phase. In response to the MU-RTS signal, the non-AP STA may transmit a clear-to-send (CTS) signal or other triggering signals to clear the channel. The NAV duration may include both the aggregation phase and the alignment phase.

As illustrated in the example of FIG. 20B, the AP may transmit a trigger frame (e.g., as part of UL sounding for alignment) to trigger one or multiple STAs, and STAs transmit sounding PPDUs (e.g., NDPs) on the several distributed resource units (DRUs) such that the total bandwidth used for the DRUs (i.e., the distribution bandwidth of the DRUs) used for alignment may be identical to the DRUs used in aggregation. The trigger frame may include the parameters and/or information discussed above.

Upon receiving the trigger frame, non-AP STAs (e.g., all non-AP STAs) may first adjust their transmit powers and apply pre-compensation for the CFO to ensure the reliability of the phase and aggregation phases. Specifically, the kth non-AP STA may apply sounding pilots located in its own DRUs and wait for the aggregation phase to transmit a PPDU for aggregation.

Once the AP receives the sounding PPDUs from STAs, it derives the UL CSI for each STA and transmits a PPDU that contains the CSI for all non-AP STAs. Once a non-AP STA obtains its CSI, it computes the correction parameters (e.g., reciprocal of the channel frequency response coefficients, conjugate of the channel frequency response) for alignment during the aggregation phase.

As illustrated in the example of FIG. 20B, the AP may transmit a trigger frame (e.g., as part of aggregation) to trigger all non-AP STAs to send the OAC PPDUs simultaneously, as shown in the example of FIG. 20B. Note that the trigger frame may be omitted in one method, and OAC PPDU may start after receiving CSI feedback.

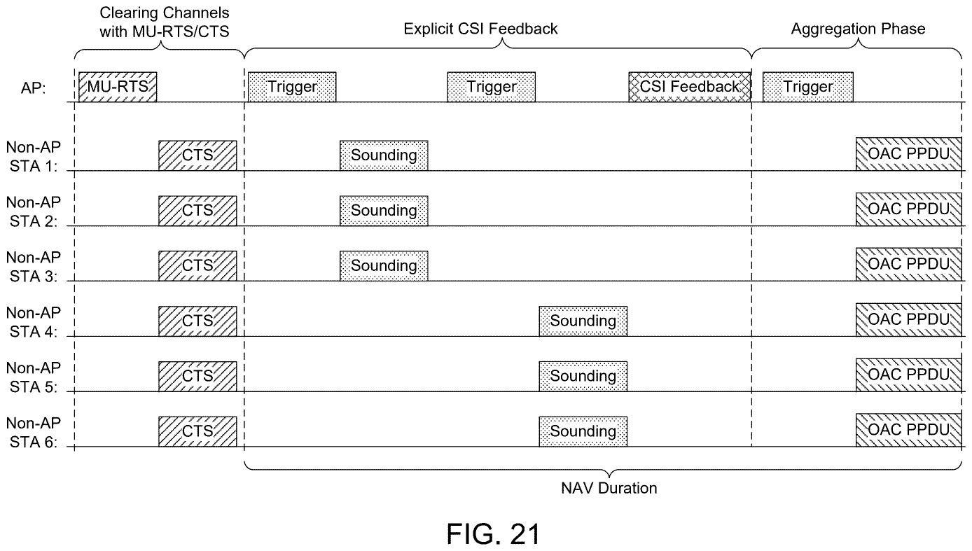

FIG. 21 illustrates an example of a parallel-sequential hybrid method, according to certain embodiments. A hybrid method uses sequential and parallel methods to reduce the duration of the sounding procedure for many non-AP STAs for OAC. In this method, the non-AP STAs may be partitioned into several groups. While the sequential method is used across the groups, the parallel method is employed for the non-AP STAs in each group. FIG. 21 demonstrates the concept in which six non-AP STAs are partitioned into two groups, i.e., {STA1, STA2, STA3} and {STA4, STA5, STA6}. The parallel method is used for the group {STA1, STA2, STA3} and the group {STA4, STA5, STA6}, sequentially. The information in the triggered frame may be the same or similar as discussed above.

Certain embodiments may include procedures for an aggregation phase. The aggregation phase may be initiated explicitly based on a trigger frame from an AP, or it may start (implicitly) after the alignment phase, as mentioned above. In the scenarios where the aggregation phase is triggered via a trigger frame, the trigger frame may include any one or more of the following information and/or parameters: the STA indices participating in the aggregation phase, the resources (e.g., RRU or DRU indices) where OAC occurs, the resources for orthogonal resources (e.g., RRU or DRU indices) for data transmissions or meta-information about the parameters, the presence of the DATA field, the parameters of the nomographic functions to be computed (e.g., indices of the inner and outer functions and their parameters), type of precoders used in the OAC PPDU transmission, the purpose of aggregation, e.g., federated learning, consensus, sensing, distributed optimization, LDPC parameters for nested-lattice-code-based OAC, constellation parameters for digital OAC PPDU transmission, mapping information for mapping the parameters to resources in the time and frequency domain, and/or the section of the model parameters or gradient vector to be updated (in some applications, only a specific layer of the neural network is trained or updated. This field will provide this information).

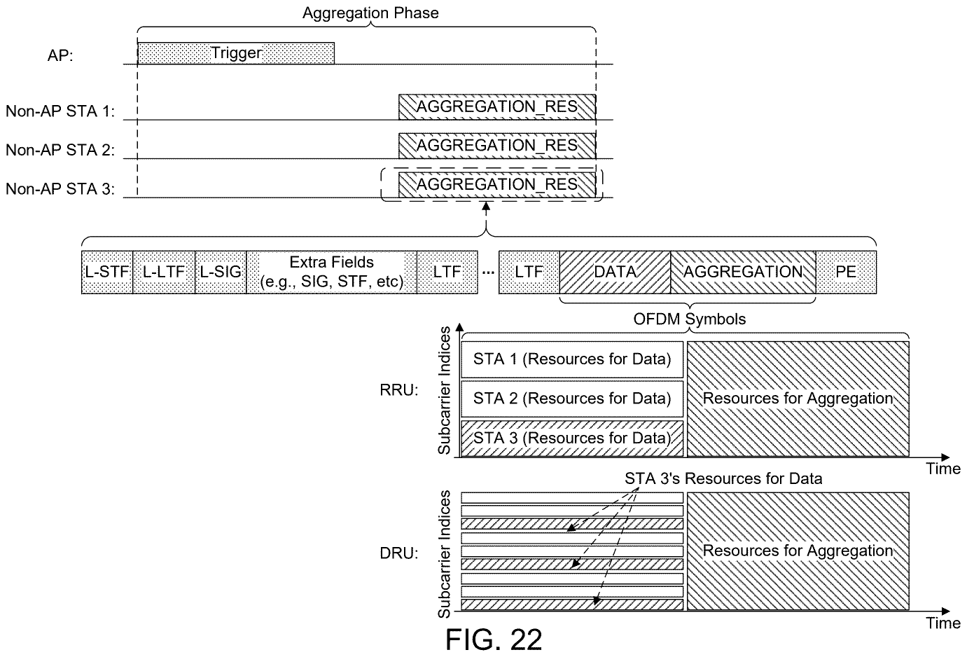

In response to the trigger frame for aggregation, a non-AP STA may prepare a specific AGGREGATION_RES PPDU. FIG. 22 illustrates an example of the structure of an OAC PPDU, according to some embodiments. The structure of this PPDU may include both DATA and AGGREGATION fields, as shown in FIG. 22.

While the AGGREGATION field may carry the parameters for OAC, the DATA field may carry some meta information regarding the parameters to be aggregated and use orthogonal resources. In this case, the DATA field may indicate any one or more of the following parameters: maximum and minimum value of the parameters to be aggregated (e.g., maximum and minimum of the gradients) or relevant statistics about the parameter distribution (e.g., mean, median), the local loss function after gradient calculations, the size of the dataset for gradient calculations for federated learning applications, and/or ACK information to indicate that it participates in the computation.

During the AGGREGATION field, a non-AP STA may reduce the transmission power as a function of the number of the STAs participating in the computation to avoid saturation at the receiver's RF circuit and analog-to-digital converter (ADC) due to the coherent aggregation (coherent aggregation increases the power by a factor K as opposed to non-coherent aggregation). For example, a non-AP STA may multiply the OFDM symbols in the AGGREGATION field by a factor of

$$\frac{1}{\sqrt{K}} ,$$

where K is the number of STAs participating in the aggregation phase. Note that the parameter K may be implicitly derived (e.g., by counting the STA indices in the trigger frame) or explicitly announced in the trigger frame. These parameters may also be announced during the setup and configuration phase.

It is noted that, in some embodiments, a non-AP STA may not be capable of OAC (i.e., aggregation without OAC as discussed above). In this case, AGGREGATION field, may be orthogonalized and each STA may transmit local computation results on the corresponding resources. They may use the same resources in DATA field.

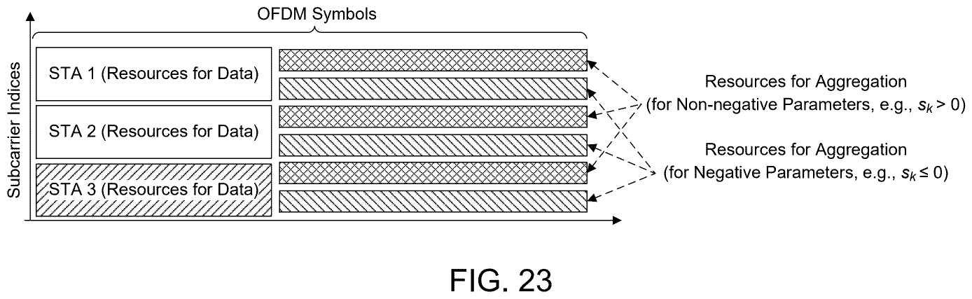

Some embodiments may include the allocation of resources for supporting non-coherent aggregation. In some cases, to improve the reliability of the OAC, the resource allocation may consider the classes or types of parameters to be aggregated. For example, for federated learning, the gradients at a non-AP STA may be positive or negative and two sets of orthogonal resources for aggregation may be considered. FIG. 23 illustrates an example of aggregating non-negative and negative-valued parameters on different resources to support non-coherent aggregation, according to certain embodiments. While the first set of aggregation resources may be allocated to only positive-valued or non-negative-valued gradients, the second set of resources may be dedicated to negative-valued gradients. In this scenario, a non-AP STA may map the absolute of the gradients, i.e., |sₖ|, to the corresponding resources as a function of the signs of the gradients (i.e., sₖ>0 or sₖ≤0) or simply activate the corresponding resources for the majority vote function computation. The AP may then calculate the energy on the resources to obtain the computation result. Since this approach does not require stringent phase synchronization among the non-AP STAs, it can enable a reliable OAC when the phase synchronization cannot be maintained. Note that the resources for positive and negative valued gradients may be shuffled or distributed in the time and frequency domain, as shown in FIG. 23, to avoid imbalanced bandwidth utilization.

In some applications, there may be more than two classes. For example, there may be four different aggregation resources dedicated to four different ranges, e.g., sₖ<a, a≤sₖ<b b≤sₖ<c, and c≤sₖ for arbitrary a<b<c. Note that the classes may also be semantically described, e.g., positive or negative comments for a recommendation system, some image classes like cat or dog, or classes for robotics such as left, right, up, or down. It is further noted that the classes and the corresponding mapping of the resources in the AGGREGATION field may be indicated in the trigger frame for the aggregation phase or the setup and configuration phase.

As introduced above, some embodiments may include procedures for a broadcasting phase. In this phase, the AP broadcasts and/or multicasts the computation results or derived parameters (e.g., aggregated model parameters or gradients) based on the OAC results to the constituents of the network. The constituents may imply the following STAs: all STAs participating in the aggregation phase, a part of the STAs participating in the aggregation phase, or some STAs that need the updated model parameters for an agile system.

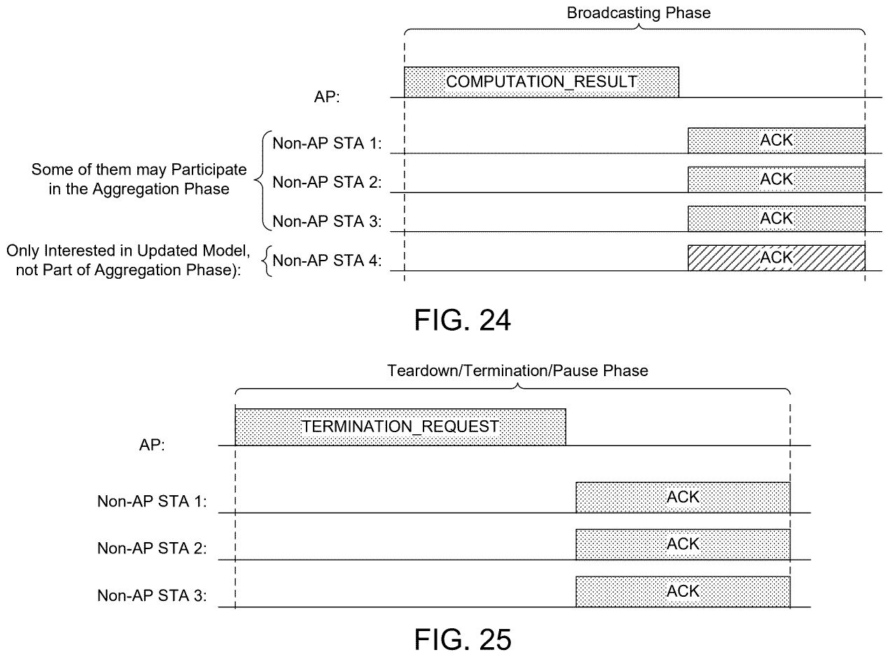

FIG. 24 illustrates an example of the broadcasting of OAC results or the derived parameters (e.g., updated neural network parameters) based on OAC results, according to some embodiments. As illustrated in the example of FIG. 24, the AP may transmit a multi-user PPDU that contains a frame regarding the OAC computation results or derived parameters, denoted as COMPUTATION_RESULT in FIG. 24. In addition to the computation results, the corresponding frame may include any one or more of the following parameters: the type of computation results (e.g., aggregated gradients, aggregated model parameters, updated parameters, and their partial transmissions), metrics related to federated learning, e.g. loss function, the intended STA indices or identities that use the computation results (multicasting), and/or the indices of the model parameters and/or the layers if the model is updated partially.

Once the intended STAs receive COMPUTATION_RESULTS from the AP, they update their parameters accordingly (e.g., neural network parameters). Then, as illustrated in the example of FIG. 24, the STAs may transmit an ACK frame to acknowledge that they receive the computation results.

As introduced above, some embodiments may include procedures associated with a teardown, termination, and/or pause phase. FIG. 25 illustrates an example of a teardown/termination/pause request and response from the non-AP STAs, according to certain embodiments. For example, in this phase, the AP may terminate the computation for a certain application, e.g., distributed neural network training with federated learning, by transmitting a TERMINATION_REQUEST frame. This frame may indicate that the non-AP STAs pause or terminate their local calculations. The TERMINATION_REQUEST frame may include any one or more of the following parameters: the purpose of termination (e.g., successful training/computation or not), the duration of termination (e.g., pause for 15 seconds-so that the non-AP STAs may acquire new data samples within this duration, or pause till requested again through or terminate training), and/or index of the model (e.g., the first neural network, second neural network, etc.—in some cases, there may be multiple neural networks aimed to be trained). As shown in the example of FIG. 25, in response to the TERMINATION_REQUEST frame, the non-AP STAs may transmit an ACK frame to acknowledge the request from the AP.

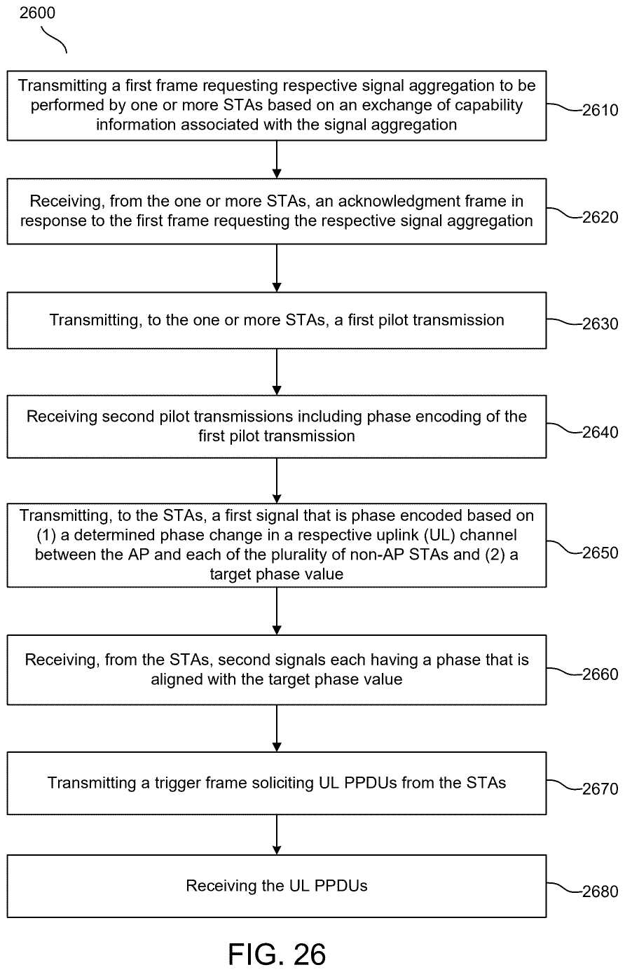

FIG. 26 illustrates an example flow diagram of a method 2600 for or relating to distributed computation and/or synchronization in wireless networks, according to some example embodiments. The example method 2600 of FIG. 26 and accompanying disclosures herein may include, may be based on, or may be a synthesization of various embodiments or elements discussed in detail above, such as those discussed with respect to FIGS. 5 to 25. For convenience and simplicity of exposition, the example of FIG. 26 may be described with reference to the architecture or system described above with respect to FIGS. 1A-1D, for instance. However, the example method 2600 depicted in FIG. 26 may be carried out using different architectures as well. According to some embodiments, the method 2600 of FIG. 3 may be implemented by an AP (e.g., as depicted in FIGS. 2-4), edge server, base station, or the like.

It is noted that the method 2600 of FIG. 26 may include further steps, procedures or details as discussed in detail elsewhere in this disclosure. As such, the method 2600 of FIG. 26 may be modified to include any of the steps, procedures, elements and/or details illustrated and/or discussed in the foregoing. Moreover, it is noted that the method and/or blocks of FIG. 26 may be modified to include, or to be replaced by, any one or more of the procedures, elements or blocks discussed elsewhere herein. As such, one of ordinary skill in the art would understand that FIG. 26 is provided as one example and modifications thereto are possible while remaining within the scope of certain example embodiments as described herein.

As illustrated in the example of FIG. 26, the method 2600 may include, at 2610, transmitting, to one or more STAs (e.g., non-AP STAs), a first frame requesting respective signal aggregation to be performed by the STAs based on an exchange of capability information associated with the signal aggregation. In some embodiments, at 2620, the method 2600 may include receiving, from the STAs, an acknowledgment frame in response to the first frame requesting the respective signal aggregation. It is noted that, in certain embodiments, the method 2600 may be performed without receiving an acknowledgement frame (i.e., the receiving 2620 of an ACK may be skipped).

In the example of FIG. 26, at 2630, the method 2600 may include transmitting, to the STAs, a first pilot transmission. At 2640, the method 2600 may include receiving, from the STAs, second pilot transmissions that may include or indicate (e.g., may each include) a phase encoding of the first pilot transmission. In an embodiment, the phase encoding of the first pilot transmission for the STAs (e.g., each of the STAs) may be based on a phase change of the first pilot transmission on respective downlink (DL) channels between the AP and the STAs (e.g., each of the STAs). In other words, the first pilot transmission may be phase encoded based on a phase change of the first pilot transmission on a DL channel between the AP and a respective STA, and the phase encoded first pilot may be included in the second pilot that may be sent to the AP.

As illustrated in the example of FIG. 26, the method 2600 may include, at 2650, transmitting, to the STAs, a first signal that is phase encoded based on (1) a determined phase change in a respective uplink (UL) channel between the AP and each of the STAs and/or (2) a target phase value. At 2660, the method 2600 may include receiving, from the STAs, second signals that have (e.g., each have or are associated with or are based on) a phase that is aligned with the target phase value.

In the example of FIG. 26, at 2670, the method 2600 may include transmitting, to the STAs, a trigger frame soliciting uplink (UL) physical protocol data units (PPDUs) from the STAs. According to an embodiment, the trigger frame may include phase information for the STAs (e.g., for each of the STAs) based on the phase encoding for the STAs (e.g., each of the STAs) meeting the target phase value. At 2680, the method 2600 may include receiving, from the STAs, the UL PPDUs. In an embodiment, the received UL PPDUs may be aggregated on the same time-frequency resources via the signal aggregation, e.g., in order to perform computation of a distributed task or for other purposes (e.g., as discussed elsewhere herein).

In an embodiment, the distributed task may include a computation over a wireless network (CoWN) task.

According to some embodiments, the method 2600 may include transmitting, to the STAs, configuration information comprising the capability information associated with a computation over a wireless network (CoWN) task.

In certain embodiments, the configuration information may further include any one or more of: an indication of a type of the computation over a wireless network (CoWN) task, parameters or rules associated with a federated learning model, hyperparameters associated with the computation of the distributed task, and/or an indication of an objective function to be optimized.

In an embodiment, the method 2600 may include receiving, from the STAs, a second frame including response information associated with performing the CoWN task based on the received capability information.

According to some embodiments, the method 2600 may include sending, to the STAs, a calibration frame indicating to perform calibration associated with any of a carrier frequency offset and a power offset, receiving an acknowledgement frame in response to the calibration frame, and determining, based on the received acknowledgement frame, that the calibration was successful.

In certain embodiments, the method 2600 may include sending, to the STAs, a multi-user request-to-send (MU-RTS) signal and an indication of a NAV duration associated with calibration, and receiving, from the STAs, a clear-to-send (CTS) signal. The method 2600 may then include sending, to the STAs, a calibration frame indicating to perform the calibration associated with any of a carrier frequency offset and a power offset, receiving an acknowledgement frame in response to the calibration frame, and determining, based on the received acknowledgement frame, that the calibration was successful.

In an embodiment, the first signal may be a function of an amplitude change associated with the respective uplink channel between the AP and each of the STAs.

In an embodiment, the second pilot transmissions may be received sequentially and/or received in parallel.

According to some embodiments, the method 2600 may include, based on the received UL PPDUs, broadcasting results associated with the computation of the distributed task to any one or more of the STAs.

In certain embodiments, the method 2600 may include transmitting, to the STAs, a termination request frame indicating to terminate or pause the respective computations, wherein the termination request frame comprises information indicating any one or more of: a purpose associated with the termination or the pause, a duration associated with the pause, and/or an index associated with a model being trained.

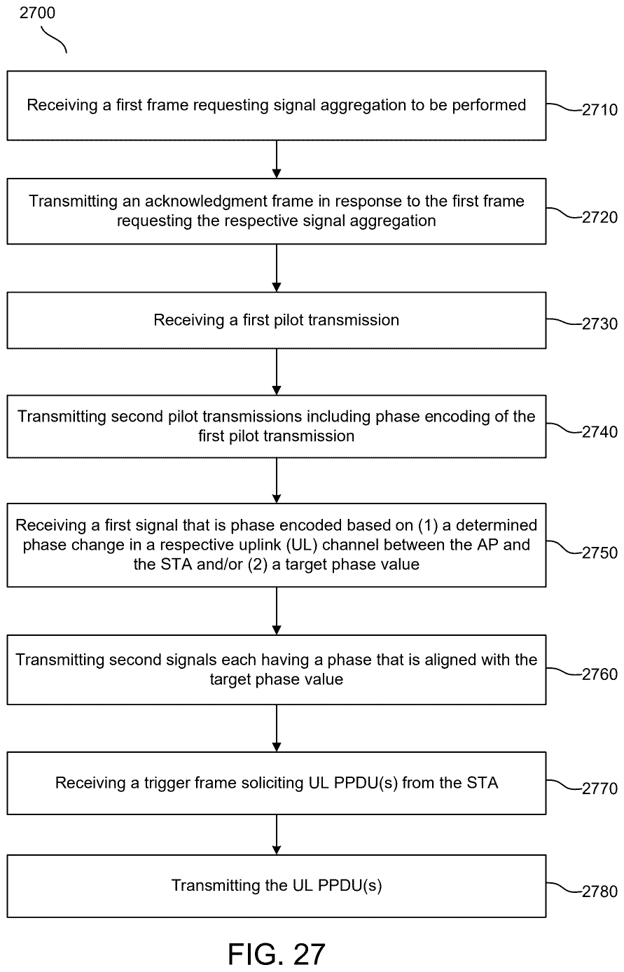

FIG. 27 illustrates an example flow diagram of a method 2700 for or relating to distributed computation and/or synchronization in wireless networks, according to some example embodiments. The example method 2700 of FIG. 27 and accompanying disclosures herein may include, may be based on, or may be a synthesization of various embodiments or elements discussed in detail above, such as those discussed with respect to FIGS. 5 to 25. For convenience and simplicity of exposition, the example of FIG. 27 may be described with reference to the architecture or system described above with respect to FIGS. 1A-1D, for instance. However, the example method 2700 depicted in FIG. 27 may be carried out using different architectures as well. According to some embodiments, the method 2700 of FIG. 3 may be implemented by a STA (e.g., as depicted in FIGS. 2-4), non-AP STA, WTRU, UE, or the like.

It is noted that the method 2700 of FIG. 27 may include further steps, procedures or details as discussed in detail elsewhere in this disclosure. As such, the method 2700 of FIG. 27 may be modified to include any of the steps, procedures, elements and/or details illustrated and/or discussed in the foregoing. Moreover, it is noted that the method and/or blocks of FIG. 27 may be modified to include, or to be replaced by, any one or more of the procedures, elements or blocks discussed elsewhere herein. As such, one of ordinary skill in the art would understand that FIG. 27 is provided as one example and modifications thereto are possible while remaining within the scope of certain example embodiments as described herein.

As illustrated in the example of FIG. 27, the method 2700 may include, at 2710, receiving, from an access point (AP), a first frame requesting signal aggregation to be performed based on an exchange of capability information associated with the signal aggregation. In some embodiments, at 2720, the method 2700 may include, at 2720, transmitting, to the AP, an acknowledgment frame in response to the first frame requesting the signal aggregation.

In the example of FIG. 27, at 2730, the method 2700 may include receiving, from the AP, a first pilot transmission. At 2740, the method 2700 may include transmitting, to the AP, a second pilot transmission comprising a phase encoding of the first pilot transmission. In an embodiment, the phase encoding of the first pilot transmission may be based on a phase change of the first pilot transmission on a downlink (DL) channel between the AP and the STA.

As illustrated in the example of FIG. 27, the method 2700 may include, at 2750, receiving, from the AP, a first signal that is phase encoded based on (1) a determined phase change in a respective uplink (UL) channel between the AP and the STA and/or (2) a target phase value. At 2760, the method 2700 may include transmitting, to the AP, a second signal having a phase that is aligned with the target phase value.

In the example of FIG. 27, at 2770, the method 2700 may include receiving, from the AP, a trigger frame soliciting an uplink (UL) physical protocol data units (PPDU). For example, in some embodiments, the trigger frame may include phase information for the STA that based on the phase encoding for the STA meeting the target phase value. At 2780, the method 2700 may include transmitting, to the AP, the UL PPDU. The UL PPDU may be (e.g., may be transmitted to be) aggregated (e.g., with other UL PPDU(s) or information from other UL PPDU(s)) on a same time-frequency resources via the signal aggregation to perform computation of a distributed task.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety.
[1] A. Şahin and R. Yang, “A Survey on Over-the-Air Computation,” in IEEE Communications Surveys & Tutorials, vol. 25, no. 3, pp. 1877-1908, third quarter 2023.

1. A method, implemented by an access point (AP), the method comprising:
transmitting, to a plurality of non-AP STAs, a first frame requesting respective signal aggregation to be performed by the plurality of non-AP STAs based on an exchange of capability information associated with the signal aggregation;
receiving, from the plurality of non-AP STAs, an acknowledgment frame in response to the first frame requesting the respective signal aggregation;
transmitting, to the plurality of non-AP STAs, a first pilot transmission;
receiving, from the plurality of non-AP STAs, second pilot transmissions each comprising a phase encoding of the first pilot transmission, wherein the phase encoding for each of the plurality of non-AP STAs is based on a phase change of the first pilot transmission on respective downlink (DL) channels between the AP and each of the plurality of non-AP STAs;
transmitting, to the plurality of non-AP STAs, a first signal that is phase encoded based on (1) a determined phase change in a respective uplink (UL) channel between the AP and each of the plurality of non-AP STAs and (2) a target phase value;
receiving, from the plurality of non-AP STAs, second signals each having a phase that is aligned with the target phase value;
transmitting, to the plurality of non-AP STAs, a trigger frame soliciting uplink (UL) physical protocol data units (PPDUs) from the plurality of non-AP STAs, wherein the trigger frame includes phase information for each of the plurality of non-AP STAs based on the phase encoding for each of the plurality of non-AP STAs meeting the target phase value; and
receiving, from the plurality of non-AP STAs, the UL PPDUs, wherein the received UL PPDUs are aggregated on a same time-frequency resources via the signal aggregation to perform computation of a distributed task.

2. The method of claim 1, wherein the distributed task comprises a computation over a wireless network (CoWN) task.

3. The method of claim 1, comprising transmitting, to the plurality of non-AP stations (STAs), configuration information comprising the capability information associated with a computation over a wireless network (CoWN) task.

4. The method of claim 3, wherein the configuration information further comprises any of: an indication of a type of the computation over a wireless network (CoWN) task, parameters or rules associated with a federated learning model, hyperparameters associated with the computation of the distributed task, an indication of an objective function to be optimized.

5. The method of claim 1, comprising receiving, from the plurality of non-AP STAs, a second frame including response information associated with performing the distributed task based on the received capability information.

6. The method of claim 1, comprising:
sending, to the plurality of non-AP STAs, a calibration frame indicating to perform calibration associated with any of a carrier frequency offset and a power offset;
receiving an acknowledgement frame in response to the calibration frame; and
determining, based on the received acknowledgement frame, that the calibration was successful.

7. The method of claim 1, comprising:
sending, to the plurality of non-AP STAs, a multi-user request-to-send (MU-RTS) signal and an indication of a NAV duration associated with calibration;
receiving, from the plurality of non-AP STAs, a clear-to-send (CTS) signal;
sending, to the plurality of non-AP STAs, a calibration frame indicating to perform the calibration associated with any of a carrier frequency offset and a power offset;
receiving an acknowledgement frame in response to the calibration frame; and
determining, based on the received acknowledgement frame, that the calibration was successful.

8. The method of claim 1, wherein the first signal is a function of an amplitude change associated with the respective uplink channel between the AP and each of the plurality of non-AP STAs.

9. The method of claim 1, wherein the second pilot transmissions are received sequentially and/or received in parallel.

10. The method of claim 1, comprising:
based on the received UL PPDUs, broadcasting results associated with the computation of the distributed task to any one or more of the non-AP STAs.

11. The method of claim 1, comprising:
transmitting, to the plurality of non-AP STAs, a termination request frame indicating to terminate or pause the respective computations, wherein the termination request frame comprises information indicating any of: a purpose associated with the termination or the pause, a duration associated with the pause, and an index associated with a model being trained.

12. An access point (AP), comprising:
circuitry, including any of a processor and transceiver, configured to
transmit, to a plurality of non-AP STAs, a first frame requesting respective signal aggregation to be performed by the plurality of non-AP STAs based on an exchange of capability information associated with the signal aggregation;
receive, from the plurality of non-AP STAs, an acknowledgment frame in response to the first frame requesting the respective signal aggregation;
transmit, to the plurality of non-AP STAs, a first pilot transmission;
receive, from the plurality of non-AP STAs, second pilot transmissions each comprising a phase encoding of the first pilot transmission, wherein the phase encoding for each of the plurality of non-AP STAs is based on a phase change of the first pilot transmission on respective downlink (DL) channels between the AP and each of the plurality of non-AP STAs;
transmit, to the plurality of non-AP STAs, a first signal that is phase encoded based on (1) a determined phase change in a respective uplink (UL) channel between the AP and each of the plurality of non-AP STAs and (2) a target phase value;
receive, from the plurality of non-AP STAs, second signals each having a phase that is aligned with the target phase value;
transmit, to the plurality of non-AP STAs, a trigger frame soliciting uplink (UL) physical protocol data units (PPDUs) from the plurality of non-AP STAs, wherein the trigger frame includes phase information for each of the plurality of non-AP STAs based on the phase encoding for each of the plurality of non-AP STAs meeting the target phase value; and
receive, from the plurality of non-AP STAs, the UL PPDUs, wherein the received UL PPDUs are aggregated on a same time-frequency resources via the signal aggregation to perform computation of a distributed task.

13. The AP of claim 12, wherein the distributed task comprises a computation over a wireless network (CoWN) task.

14. The AP of claim 12, comprising transmitting, to the plurality of non-AP stations (STAs), configuration information comprising the capability information associated with a computation over a wireless network (CoWN) task.

15. The AP of claim 14, wherein the configuration information further comprises any of: an indication of a type of the computation over a wireless network (CoWN) task, parameters or rules associated with a federated learning model, hyperparameters associated with the computation of the distributed task, an indication of an objective function to be optimized.

16. The AP of claim 12, configured to receive, from the plurality of non-AP STAs, a second frame including response information associated with performing the distributed task based on the received capability information.

17. The AP of claim 12, configured to:
send, to the plurality of non-AP STAs, a calibration frame indicating to perform calibration associated with any of a carrier frequency offset and a power offset;
receive an acknowledgement frame in response to the calibration frame; and
determine, based on the received acknowledgement frame, that the calibration was successful.

18. The AP of claim 12, configured to:
send, to the plurality of non-AP STAs, a multi-user request-to-send (MU-RTS) signal and an indication of a NAV duration associated with calibration;
receive, from the plurality of non-AP STAs, a clear-to-send (CTS) signal;
send, to the plurality of non-AP STAs, a calibration frame indicating to perform the calibration associated with any of a carrier frequency offset and a power offset;
receive an acknowledgement frame in response to the calibration frame; and
determine, based on the received acknowledgement frame, that the calibration was successful.

19. The AP of claim 12, wherein the first signal is a function of an amplitude change associated with the respective uplink channel between the AP and each of the plurality of non-AP STAs.

20. The AP of claim 12, wherein the second pilot transmissions are received sequentially and/or received in parallel.

21. The AP of claim 12, configured to:
based on the received UL PPDUs, broadcast results associated with the computation of the distributed task to any one or more of the non-AP STAs.

22. The AP of claim 12, configured to:
transmit, to the plurality of non-AP STAs, a termination request frame indicating to terminate or pause the respective computations, wherein the termination request frame comprises information indicating any of: a purpose associated with the termination or the pause, a duration associated with the pause, and an index associated with a model being trained.

23. A station (STA), comprising:
circuitry, including any of a processor and transceiver, configured to
receive, from an access point (AP), a first frame requesting signal aggregation to be performed based on an exchange of capability information associated with the signal aggregation;
transmit, to the AP, an acknowledgment frame in response to the first frame requesting the signal aggregation;
receive, from the AP, a first pilot transmission;
transmit, to the AP, a second pilot transmission comprising a phase encoding of the first pilot transmission, wherein the phase encoding is based on a phase change of the first pilot transmission on a downlink (DL) channel between the AP and the STA;
receive, from the AP, a first signal that is phase encoded based on (1) a determined phase change in a respective uplink (UL) channel between the AP and the STA and (2) a target phase value;
transmit, to the AP, a second signal having a phase that is aligned with the target phase value;
receive, from the AP, a trigger frame soliciting an uplink (UL) physical protocol data units (PPDU), wherein the trigger frame includes phase information for the STA that based on the phase encoding for the STA meeting the target phase value; and
transmit, to the AP, the UL PPDU, wherein the UL PPDU is aggregated on a same time-frequency resources via the signal aggregation to perform computation of a distributed task.
